(19) United States
(12) Patent Application Publication
(10) Pub. No.: US 2016/0326300 A1
(43) Pub. Date: Nov. 10, 2016

(54) CROSSLINKED EPOXY PARTICLES AND METHODS FOR MAKING AND USING THE SAME

(71) Applicant: 3M INNOVATIVE PROPERTIES COMPANY, Saint Paul,, MN (US)

(72) Inventors: Genaro A. Gelves, Calgary (CA); Mohit Malik, Calgary (CA); Bethany A. Turowec, Calgary (CA)

(73) Assignee: 3M INNOVATIVE PROPERTIES COMPANY, Saint Paul, MN (US)

(21) Appl. No.: 15/108,173

(22) PCT Filed: Dec. 19, 2014
(86) PCT No.: PCT/US2014/071627

§ 371 Date: Jun. 24, 2016

Related U.S. Application Data
(60) Provisional application No. 61/921,146, filed on Dec. 27, 2013.
(60) Provisional application No. 62/089,475, filed on Dec. 9, 2014.

(51) Int. Cl. C08G 59/50; E21B 43/26; E21B 43/267; C08L 63/00; C09K 8/80

(52) U.S. Cl. CPC C08G 59/5033; C08G 59/5026; C08L 63/00; C09K 8/80; E21B 43/267; E21B 43/26; C08L 2205/025; C08L 2205/03; C09K 2208/04

(57) ABSTRACT

A plurality of solid polymer particles including an aromatic epoxy crosslinked with a hardener having at least two amino groups and at least one of an aromatic ring or a cycloaliphatic ring is disclosed. The solid polymer particles are useful, for example, as proppants. Mixtures of the plurality of particles and other particles, fluids containing the plurality of particles, methods of making the plurality of particles, and methods of fracturing a subterranean geological formation are also disclosed.

### CROSS-REFERENCE TO RELATED APPLICATION

This application claims priority to U.S. Provisional Application No. 61/921,146, filed Dec. 27, 2013, and 62/089,475, filed Dec. 9, 2014, the disclosures of which are incorporated by reference in their entirety herein.

### BACKGROUND

Oil and natural gas can be produced from wells having porous and permeable subterranean formations. The porosity of the formation permits the formation to store oil and gas, and the permeability of the formation permits the oil or gas fluid to move through the formation. Permeability of the formation is essential to permit oil and gas to flow to a location where it can be pumped from the well. Sometimes the permeability of the formation holding the gas or oil is insufficient for the desired recovery of oil and gas. In other cases, during operation of the well, the permeability of the formation drops to the extent that further recovery becomes uneconomical. In such cases, it is common to fracture the formation and prop the fracture in an open condition using a proppant material or propping agent. The proppant material or propping agent is typically a particulate material, such as sand and (man-made) engineered proppants, such as resin coated sand and high-strength ceramic materials (e.g., sintered bauxite, crystalline ceramic bubbles, and ceramic (e.g., glass) beads), which are carried into the fracture by a fluid.

The extreme environments of temperature and pressure in a fracture and exposure to various chemicals in fracturing fluids provide many challenges for proppant materials. While certain crosslinked polymers have been used as proppants, there continues to be interest in finding polymeric materials that can withstand the challenging environment in a fractured formation.

### SUMMARY

Particles that typically demonstrate properties that exceed those of commercially available polymer proppant particles are disclosed herein. For example, the particles disclosed herein typically have greater resistance to swelling in solvents than commercially available polymer proppant particles. Furthermore, the particles disclosed herein typically have better compressive strength at higher temperatures and/or pressure than commercially available polymer proppant particles. These properties may render the plurality of particles according to the present disclosure more versatile than commercially available materials. For example, when used as proppants the plurality of particles according to the present disclosure may be useful at greater depths in subterranean formations than currently available polymer proppants.

In one aspect, the present disclosure provides a plurality of solid polymer particles including a multifunctional aromatic epoxy crosslinked with a hardener having at least two amino groups and at least one of an aromatic ring or a cycloaliphatic ring. At least 90% by weight of the solid polymer particles have a size in a range from 150 micrometers to 3000 micrometers

In another aspect, the present disclosure provides a plurality of solid polymer particles including a multifunctional aromatic epoxy crosslinked with a hardener comprising at least two amino groups and at least one of an aromatic ring or a cycloaliphatic ring. Substantially all of the solid polymer particles have a size in a range from 150 micrometers to 3000 micrometers.

In another aspect, the present disclosure provides a plurality of solid polymer particles including a multifunctional aromatic epoxy crosslinked with a hardener comprising at least two amino groups and at least one of an aromatic ring or a cycloaliphatic ring. A particle in the plurality of solid polymer particles has a compressive strength measured at 150° C. of at least 90 megapascals.

In another aspect, the present disclosure provides a plurality of crosslinked epoxy particles each having a density of up to 1.4 grams per milliliter and a compressive strength measured at 150° C. of at least 90 megapascals.

In another aspect, the present disclosure provides a plurality of solid polymer particles including a multifunctional aromatic epoxy crosslinked with a hardener having at least two amino groups and at least one of an aromatic ring or a cycloaliphatic ring for use as proppants.

In another aspect, the present disclosure provides a method of making a plurality of particles according to any of the foregoing aspects. The method includes providing a mixture including an aromatic epoxy resin having at least two epoxy functional groups and a hardener comprising at least two amino groups and at least one of an aromatic ring or a cycloaliphatic ring, suspending the mixture in a solution comprising water to form a suspension, and initiating crosslinking of the aromatic epoxy resin to make the plurality of solid polymer particles.

In another aspect, the present disclosure provides a plurality of mixed particles including the plurality of solid polymer particles according to and/or prepared according to any of the foregoing aspects and other, different particles.

In another aspect, the present disclosure provides a fluid including a plurality of solid polymer particles according to and/or prepared according to any of the foregoing aspects dispersed therein.

In another aspect, the present disclosure provides a method of fracturing a subterranean geological formation penetrated by a wellbore. The method includes injecting into the wellbore penetrating the subterranean geological formation a fracturing fluid at a rate and pressure sufficient to form a fracture therein and introducing into the fracture a plurality of solid polymer particles described above, a plurality of mixed particles described above, or a fluid described above.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated.

The term “plurality” refers to more than one. In some embodiments, the plurality of particles disclosed herein comprises at least 2, 10, 100, or 1000 of such particles.

The term “crosslink” refers to joining polymer chains together by covalent chemical bonds, usually via crosslinking molecules or groups, to form a network polymer. A crosslinked polymer is generally characterized by insolubility, but may swell in the presence of certain solvents.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### DETAILED DESCRIPTION

Crosslinked aromatic epoxies (that is, epoxy polymers) as described herein will be understood to be preparable by crosslinking aromatic epoxy resins. The crosslinked aromatic epoxy typically contains a repeating unit with at least one (in some embodiments, at least 2, in some embodiments, in a range from 1 to 4) aromatic ring (e.g., phenyl group) that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo).

In some embodiments, the crosslinked aromatic epoxy is a novolac epoxy. In these embodiments, the novolac epoxy may be a phenol novolac, an ortho-, meta-, or para-cresol novolac, or a combination thereof. In some embodiments, the crosslinked aromatic epoxy is a bisphenol diglycidyl ether, wherein the bisphenol (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. The crosslinked epoxy may also comprise units derived from a combination of epoxy resins, for example, novolac and bisphenol types of epoxy resins.

Epoxy resins useful for preparing crosslinked aromatic epoxies are typically prepared, for example, beginning with an aromatic polyepoxide (e.g., a chain-extended diepoxide or novolac epoxy resin having at least two epoxide groups) or a monomeric diepoxide. A crosslinkable epoxy resin therefore typically will have at least two epoxy end groups. The aromatic polyepoxide or aromatic monomeric diepoxide typically contains at least one (in some embodiments, at least 2, in some embodiments, in a range from 1 to 4) aromatic ring that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resins containing two or more aromatic rings, the rings may be connected, for example, by a branched or straight-chain alkylene group having 1 to 4 carbon atoms that may optionally be substituted by halogen (e.g., fluoro, chloro, bromo, iodo).

Examples of aromatic epoxy resins useful for preparing the crosslinked aromatic epoxies and solid polymer particles disclosed herein include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, tetrakis phenylolethane epoxy resins and combinations of any of these. Examples of aromatic monomeric diepoxides useful for preparing the crosslinked aromatic epoxies disclosed herein include the diglycidyl ethers of bisphenol A and bisphenol F and mixtures thereof.

In some embodiments, bisphenol epoxy resins, for example, may be chain extended to have any desirable epoxy equivalent weight. Chain extending epoxy resins can be carried out by reacting a monomeric diepoxide, for example, with a bisphenol in the presence of a catalyst to make a linear polymer. In some embodiments, the aromatic epoxy resin (e.g., either a bisphenol epoxy resin or a novolac epoxy resin) may have an epoxy equivalent weight of at least 150, 170, 200, or 225 grams per equivalent. In some embodiments, the aromatic epoxy resin may have an epoxy equivalent weight of up to 2000, 1500, or 1000 grams per equivalent. In some embodiments, the aromatic epoxy resin may have an epoxy equivalent weight in a range from 150 to 2000, 150 to 1000, or 170 to 900 grams per equivalent. Epoxy equivalent weights may be selected, for example, so that the epoxy resin may be used as a liquid.

In some embodiments of the solid polymer particles according to the present disclosure, it is useful for at least one of the molecular weight between crosslinks to vary in the crosslinked network or to incorporate a flexible, non-aromatic chain into the crosslinked network. In some of these embodiments, at least one of the compression strength or the maximum deformation before fracture of the solid polymer particles is increased relative to crosslinked aromatic epoxies having a more uniform molecular weight between crosslinks or having no flexible, non-aromatic chains in the crosslinked network.

Varying the molecular weight between crosslinks can be carried out, in some embodiments, by using a combination of at least two different epoxy resins with different epoxy equivalent weights. A first epoxy equivalent weight may be selected, for example, so that the first epoxy resin is a liquid. A second epoxy equivalent weight may be selected, for example, so that the second epoxy resin is a solid. In some embodiments, the first aromatic epoxy resin has an epoxy equivalent weight in a range from 150 to 450, 150 to 350, or 150 to 300 grams per equivalent. In some embodiments, the second aromatic epoxy resin has an epoxy equivalent weight in a range from 450 to 2000, 450 to 1000, or 500 to 900 grams per equivalent.

In some embodiments, the plurality of solid polymer particles incorporates a non-aromatic epoxy into the crosslinked epoxy network. The non-aromatic epoxy can include a branched or straight-chain alkylene group having 1 to 20 carbon atoms optionally interrupted with at least one —O— and optionally substituted by hydroxyl. In some embodiments, the non-aromatic epoxy can include a poly(oxyalkylene) group having a plurality (x) of oxyalkylene groups, OR¹, wherein each R¹ is independently C₂ to C₅ alkylene, in some embodiments, C₂ to C₃ alkylene, x is 2 to about 6, 2 to 5, 2 to 4, or 2 to 3. To become crosslinked into the crosslinked network, useful non-aromatic epoxy resins will typically have at least two epoxy end groups. Examples of useful non-aromatic epoxy resins include glycidyl epoxy resins such as those based on diglycidyl ether compounds comprising one or more oxyalkylene units. Examples of these include resins made from ethylene glycol diglycidyl ether, propylene glycol diglycidyl ether, diethylene glycol diglycidyl ether, dipropylene glycol diglycidyl ether, polyethylene glycol diglycidyl ether, polypropylene glycol diglycidyl ether, glycerol diglycidyl ether, glycerol triglycidyl ether, propanediol diglycidyl ether, butanediol diglycidyl ether, and hexanediol diglycidyl ether. In some embodiments, the non-aromatic epoxy is present at up to 20 (in some embodiments, 15, 10, 9, 8, 7, 6, or 5) percent by weight, based on the total weight of epoxy resin used to make the crosslinked epoxy network. Including more non-aromatic epoxy into the crosslinked epoxy network would tend to lead to glass transition temperatures that are too low for high-temperature applications and inferior compression strengths.

In some embodiments, the crosslinked epoxy is crosslinked by a hardener comprising at least two amino groups and at least one of an aromatic ring or a cycloaliphatic ring. The amino groups in the hardener are each independently primary or secondary amino groups. Typically, at least one of the amino groups is a primary amino group so that a crosslinked network may form.

The crosslinked aromatic epoxy polymer will typically have crosslinked units represented by formula,

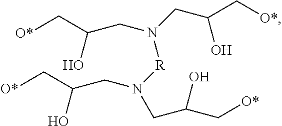

wherein R is an aryl, arylalkylene, or alkylene-arylalkylene group as described below, and wherein * indicates that the O is bonded to the epoxide backbone, usually to an aromatic ring, although in some embodiments, to a branched or straight-chain alkylene group having 1 to 20 carbon atoms optionally interrupted with at least one —O— and optionally substituted by hydroxyl as described above.

For a hardener that comprises at least two amino groups and at least one aromatic ring, the hardener may be an aromatic polyamine, in which the amino groups are bonded directly to the aromatic ring, or an arylalkylenyl polyamine, in which the amino groups are bonded to alkylene groups that are in turn bonded to the aromatic ring. A hardener may also contain two or more aromatic rings and at least two amino groups. In any of these embodiments, the aromatic ring can be unsubstituted or substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For amines containing two or more aromatic rings, the rings may be directly connected or connected, for example, by a branched or straight-chain alkylene group having 1 to 4 carbon atoms that may optionally be substituted by halogen (e.g., fluoro, chloro, bromo, iodo), an oxygen, a sulfur, or a sulfone group. Examples of suitable hardeners that comprise at least two amino groups and at least one aromatic ring include phenylenediamine (e.g., meta-phenylenediamine or para-phenylenediamine), diethyl toluene diamine (e.g., in any of its isomeric forms), diamino toluene (e.g., 2,3-diaminotoluene and 3,4-diaminotoluene, and methyl-m-phenylenediamine), 1,2-diamino-3,5-dimethylbenzene, 4,5-dimethyl-1,2-phenylenediamine, 2,4,6-trimethyl-m-phenylenediamine, 2,3,5,6-tetramethyl-p-phenylenediamine, aminobenzylamines (e.g., 2-aminobenzylamine and 4-aminobenzylamine), ethylenedianiline, 2,2′-biphenyldiamine, diaminodiphenylmethane, diaminodiphenylsulfone, halogenated substituted phenylene diamines (e.g., 4-chloro-1,3-diaminobenzene, 4-chloro-1,2-diaminobenzene, and 4-bromo-1,2-diaminobenzene), a xylylenediamine (e.g., ortho-xylylenediamine or meta-xylylenediamine), and 4-(2-aminoethyl)aniline.

For a hardener that comprises at least two amino groups and at least one cycloaliphatic ring, the amino groups may be bonded directly to the cycloaliphatic ring, or the amino groups may be bonded to straight-chain or branched alkylene groups that are in turn bonded to the aromatic ring. A hardener may also contain two or more cycloaliphatic rings and at least two amino groups. In any of these embodiments, the cycloaliphatic ring can be unsubstituted or substituted by a halogen (e.g., fluoro, chloro, bromo, iodo), straight-chain or branched alkyl having 1 to 4 carbon atoms (e.g., methyl or ethyl), or hydroxyalkyl having 1 to 4 carbon atoms (e.g., hydroxymethyl). In any of these embodiments, the cycloaliphatic ring may be a carbocyclic ring, for example, including no heteroatoms such as sulfur or nitrogen. For amines containing two or more cycloaliphatic rings, the rings may be directly connected or connected, for example, by a branched or straight-chain alkylene group having 1 to 4 carbon atoms that may optionally be substituted by halogen (e.g., fluoro, chloro, bromo, iodo), an oxygen, a sulfur, or a sulfone group. Examples of suitable hardeners that comprise at least two amino groups and at least one cycloaliphatic group are the fully or partially hydrogenated products of any of the hardeners that comprise at least two amino groups and at least one aromatic ring described above. For example, suitable hardeners include diaminocyclohexanes (e.g., 1,2-diaminocyclohexane or 1,4-diaminocyclohexane in their cis- or trans-forms) and 3-aminomethyl-3,5,5-trimethylcyclohexylamine (also called isophorone diamine).

It can be useful to for the aromatic epoxy to be crosslinked with a mixture of hardeners. For example, using two or more different hardeners comprising at least two amino groups and at least one of an aromatic ring or a cycloaliphatic ring may be useful. Any two or more of the hardeners listed above may be useful in any combination. In some embodiments, aromatic epoxy is crosslinked with a mixture of hardeners that includes an alkylene polyamine, for example, a linear or branched alkylene polyamine. Useful alkylene polyamines include ethylene amines (e.g., ethylenediamine, diethylenetriamine, triethylenetetramine, etc.), propylamines (e.g., dimethylaminopropyl amine, diethylaminopropylamine, and cyclohexylaminopropylamine), higher alkylenediamines (e.g., hexamethylenediamine, methylpentamethylenediamine, and trimethylhexanediamine), polyetheramines (e.g., polyoxyalkylene diamines such as polyoxypropylene diamines of various molecular weights. Although alkylene polyamines can be useful in combination with hardeners that comprise at least two amino groups and at least one of an aromatic ring or a cycloaliphatic ring, alkylene polyamines used alone to crosslink aromatic epoxy resins typically lead to glass transition temperatures that are too low for high-temperature applications and have crush strengths that are inferior to those that can be achieved by the solid polymer particles disclosed herein. Accordingly, in some embodiments, the hardener or mixture of hardeners useful for providing the solid polymer particles has alkylene polyamines is up to about 20%, 15%, or 10% by weight based on the total weight of the hardener. In some embodiments, the hardener or mixture of hardeners useful for providing the solid polymer particles is substantially free of alkylene polyamines, for example, linear or branched alkylene polyamines. The phrase “substantially free of alkylene polyamines” refers to reaction mixtures having no linear or branched alkylene polyamines as well as mixtures having up to 2%, 1%, 0.5%, or 0.25% by weight of linear or branched alkylene polyamines, based on the total weight of the reaction mixture.

A plurality of solid polymer particles comprising a crosslinked aromatic epoxy according to the present disclosure can be made, for example, by suspension polymerization. Typically, a mixture of at least one aromatic epoxy resin having at least two epoxide groups, at least one hardener comprising at least two amino groups and at least one of an aromatic ring or a cycloaliphatic ring, and optionally a catalyst is suspended in a solution comprising water (i.e., an aqueous solution) to form a suspension. The mixture can be made by stirring the mixture of components together before combining the mixture and the aqueous solution. Typically, the suspension is made by stirring the mixture in the aqueous solution to form beads of the mixture suspended in the aqueous solution. Initiating crosslinking of the epoxy resin can be carried out, for example, by heating. Heating the suspension will cause the epoxide groups and amino groups to react and crosslink to form the plurality of particles. In some embodiments, for example, when a catalyst is present either in the mixture or in the suspension, heating may not be necessary. However, in many embodiments, the crosslinking is carried out in the absence of a catalyst.

The aromatic epoxy resin that can be polymerized using this method can be any of those described above. For example, in some embodiments, the aromatic epoxy resin is a novolac epoxy resin. In these embodiments, the novolac epoxy resin may be a phenol novolac, an ortho-, meta-, or para-cresol novolac, or a combination thereof. In some embodiments, the aromatic epoxy resin is a bisphenol diglycidyl ether resin, wherein the bisphenol (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. A combination of different types of aromatic epoxy resins may also be useful. In some embodiments, it is advantageous to use epoxy resins instead of epoxide compounds (that is, monomeric compounds), for example, to obtain a desirable crosslink density in the plurality of particles.

In some embodiments, for the reasons described above, it is useful to use a combination of at least two different epoxy resins with different epoxy equivalent weights in the polymerization reaction. In some embodiments, the first aromatic epoxy resin has an epoxy equivalent weight in a range from 150 to 450, 150 to 350, or 150 to 300 grams per equivalent. In some embodiments, the second aromatic epoxy resin has an epoxy equivalent weight in a range from 450 to 2000, 450 to 1000, or 500 to 900 grams per equivalent. In some embodiments, the first aromatic epoxy resin is a liquid, and the second aromatic epoxy resin is a solid.

In some embodiments, the mixture of components for making the solid polymer particles includes a non-aromatic epoxy resin. The non-aromatic epoxy resin can include a branched or straight-chain alkylene group having 1 to 20 carbon atoms optionally interrupted with at least one —O— and optionally substituted by hydroxyl. For example, the non-aromatic epoxy can include a polyoxyalkylene group. Examples of useful non-aromatic epoxy resins any of those described above. In some embodiments, the non-aromatic epoxy resin is present in the mixture at up to 20 (in some embodiments, 15, 10, 9, 8, 7, 6, or 5) percent by weight, based on the total weight of epoxy resins in the mixture. In some of these embodiments, at least one of the compression strength or the maximum deformation before fracture of the solid polymer particles is increased relative to crosslinked aromatic epoxies made from a mixture containing no non-aromatic epoxy resin. In other embodiments, the mixture of components useful for providing the solid polymer particles is substantially free of non-aromatic epoxy resins. The phrase “substantially free of non-aromatic epoxy resins” refers to resin mixtures having no non-aromatic epoxy resins as well as mixtures having up to 2%, 1%, 0.5%, or 0.25% by weight of non-aromatic epoxy resins, based on the total weight of the resins.

The hardener included in the mixture and copolymerized with the aromatic epoxy resin can be one or more of those described above comprising at least two amino groups and at least one of an aromatic ring or a cycloaliphatic ring. A mixture of hardeners including an alkylene polyamine as described above may also be useful. The hardener may be present in the mixture in a stoichiometric amount. That is, primary and secondary amines present in the mixture in an amount that provides one amine active hydrogen for each epoxy group. In some embodiments, the hardener is present in an amount in excess of the stoichiometric amount. For example, the hardener may be present in 5, 10, 15, 20, 25, 30, 35, 40, 45, or 50 percent excess of the stoichiometric amount.

Several aromatic epoxy resins and hardeners useful for preparing the plurality of solid polymer particles according to and/or prepared according to the present disclosure are commercially available. For example, several epoxy resins of various classes and epoxy equivalent weights are available from Dow Chemical Company, Midland, Mich.; Momentive Specialty Chemicals, Inc., Columbus, Ohio; Huntsman Advanced Materials, The Woodlands, Tex.; CVC Specialty Chemicals Inc. Akron, Ohio (acquired by Emerald Performance Materials); and Nan Ya Plastics Corporation, Taipei City, Taiwan. Several hardeners including at least two amino groups and at least one of an aromatic ring or a cycloaliphatic ring are available, for example, from Lonza, Basel, Switzerland, and Amberlite Corporation, Baton Rouge, La. Other hardeners that may be useful in a mixture of hardeners include polyetheramines available, for example, from Huntsman Chemical, The Woodlands, Tex., under the trade designation “JEFFAMINE”.

Examples of catalysts that may be useful for accelerating the cure of epoxy resins and the hardeners described above in any of their embodiments include tertiary amines and imidazoles. Suitable tertiary amines include benzyldimethylamine, diazabicycloundecene, and tertiary amines that include phenolic hydroxyl groups (e.g., dimethylaminomethylphenol and tris(dimethylaminomethyl)phenol. Any suitable amount of catalyst may be used, depending on the desired reaction rate. In some embodiments, the amount of catalyst is in a range from 0.1 to 5 (in some embodiments, 0.5 to 3, or 0.5 to 2.5) percent by weight, based on the total weight of the mixture.

The temperature to which the suspension is heated can be selected by those skilled in the art based on considerations such as the particular reagents used and whether a catalyst is present. While it is not practical to enumerate a particular temperature suitable for all situations, generally suitable temperatures are in a range from about 30° C. to about 200° C. In some embodiments wherein no catalyst is used, generally suitable temperatures are in a range from about 70° C. to about 120° C., or from about 80° C. to about 110° C. Heating can be carried out using a variety of techniques. For example, the suspension can be stirred in a flask that is placed on a hot plate or water or oil bath.

The suspension polymerization advantageously can be carried out in the absence of volatile organic solvent. Accordingly, in some embodiments, the aqueous solution used for suspension polymerization is essentially free of volatile organic solvent. Also, the plurality of particles according to the present disclosure may be free of volatile organic solvents. Volatile organic solvents are typically those have a boiling point of up to 150° C. at atmospheric pressure. Examples of these include esters, ketones, and toluene. “Essentially free of volatile organic solvent” can mean that volatile organic solvent may be present (e.g., from a previous synthetic step or in a commercially available monomer) in an amount of up to 2.5 (in some embodiments, up to 2, 1, 0.5, 0.1, 0.05, or 0.01) percent by weight, based on the total weight of the plurality of particles. Advantageously, the plurality of particles disclosed herein can be made without an expensive manufacturing step of removing organic solvent.

Before the aromatic epoxy resin (and optionally, the non-aromatic epoxy resin) and the hardener, for example, comprising at least two amino groups and at least one of an aromatic ring or a cycloaliphatic ring, are suspended in water to make the solid polymer particles, it can be useful to pre-react the epoxy resin and the hardener. The epoxy resin and hardener may be combined in the desired ratio as described above and heated together at an elevated temperature at which both components are liquid. Typically, the pre-reaction can be carried out in the absence of solvent, and the neat components can be heated together. When no catalyst is used, generally suitable temperatures are in a range from about 70° C. to about 120° C., or from about 80° C. to about 110° C. The liquid can be stirred for up to one hour, 40 minutes, 30 minutes, or in some embodiments about 20 minutes to pre-react the epoxy resin and the hardener before it is suspended in water and the final crosslinked particles are prepared.

In some embodiments of the method according to the present disclosure, the aqueous solution comprises a suspending agent, which may be either an organic or inorganic suspending agent. Exemplary useful suspending agents include cellulose polymers (e.g., methyl cellulose, carboxy methyl cellulose, carboxymethyl methyl cellulose, hydroxyethyl cellulose, hydroxypropyl methyl cellulose, and hydroxybutyl methyl cellulose); gelatin; polyvinylalcohol; partially hydrolyzed polyvinyl alcohol; acrylate polymers and methacrylate polymers (e.g., polymethacrylic acid, sodium poly(methacrylic acid) and ammonium poly(methacrylic acid)); poly(styrene sulfonates) (e.g., sodium poly(styrene sulfonate)); talc; hydroxyapatite; barium sulfate; kaolin; magnesium carbonate; magnesium hydroxide; calcium phosphate; and aluminum hydroxide. Any amount of suspending agent useful for maintaining the solid polymer particles in suspension may be used. For example, a range of 1 gram to 10 grams of suspending agent for one liter of water may be useful. In some embodiments, a range of 2.5 grams to 7.5 grams per liter of water or about 5 grams per liter of water may be useful. In some embodiments, the suspending agent is a cellulose polymer (e.g., methyl cellulose, carboxy methyl cellulose, carboxymethyl methyl cellulose, hydroxyethyl cellulose, hydroxypropyl methyl cellulose, and hydroxybutyl methyl cellulose). In some embodiments, the suspending agent is hydroxyethyl cellulose (HEC).

In some embodiments, the suspending agent is not a polyolefin comprising pendent carboxylic acid, carboxylic acid anhydride, amide, and carboxylic acidimide groups. In these embodiments, the particles are essentially free of a polyolefin comprising pendent carboxylic acid, carboxylic acid anhydride, amide, and carboxylic acidimide groups. In this context, “essentially free” of the polyolefin can mean that the particles include none of such a polyolefin. In other embodiments, solid polymer particles that are “essentially free” of the polyolefin may comprise up to 0.5 (in some embodiments, 0.25, 0.1, or 0.01) percent by weight of the polyolefin, based on the total weight of the particles. In some embodiments, the suspending agent is not a polyvinyl alcohol.

In some embodiments of the method of making a plurality of solid polymer particles according to the present disclosure, the method further comprises separating the plurality of solid polymer particles from the solution comprising water and subjecting the plurality of solid polymer particles to post-polymerization heating at a temperature of at least 130° C. Separating the plurality of particles can be carried out using conventional techniques (e.g., filtering or decanting). Optionally the suspension can be filtered through at least one sieve to collect a desired graded fraction of the plurality of particles. Post-polymerization heating can advance crosslinking and network formation as described further below. In some embodiments, the particles disclosed herein are subjected to post-polymerization heating at a temperature of at least 135° C. (in some embodiments, at least 140° C., 145° C., 150° C., or 155° C.). Post-polymerization heating can be carried out at any temperature in a range, for example, from 130° C. to 220° C. Post-polymerization heating can conveniently be carried out in an oven, typically for at least 30 minutes, although longer periods of time may be useful. For example, post-polymerization heating can be carried out for up to 12, 10, 8, or 5 hours. Post-polymerization heating can be carried out at a single temperature or more than one temperature. For example, the plurality of particles may be heated at 90° C. or 100° C. for a first period of time (e.g., in a range from 15 to 60 minutes) and then at successively higher temperature (e.g., in a range from 110° C. to 200° C.) each for a second period of time (e.g., in a range from 15 to 120 minutes). Post-polymerization heating can increase the level of crosslinking (that is, increase crosslink density) which may improve the compressive strength and solvent resistance of the solid polymer particles in some embodiments.

Particles according to the present disclosure typically demonstrate high compressive strength. In some embodiments, particles according to the present disclosure can be exposed to pressure (e.g., up to 50 megapascals (MPa), 75 MPa, 100 MPa, or 125 MPa) and temperature (e.g., up to 100° C., 110° C., 120° C., 130° C., 140° C., 150° C., or higher) while having a maximum deformation of up to 65 (in some embodiments, 60, 55, 50, or 45 percent) before fracture. While the particles fracture during the evaluation, they stay in one piece, that is, they don't shatter. In many embodiments of the plurality of solid polymer particles disclosed herein, a particle from the plurality of particles has a compressive strength of at least 45 (in some embodiments, at least 55, 65, or 75) MPa and up to 85, 95, or 100 MPa at a temperature of 150° C. In some embodiments of the plurality of solid polymer particles, substantially all of the particles in the plurality of solid polymer particles have a compressive strength of at least 45 (in some embodiments, at least 55, 65, or 75) MPa at a temperature of 150° C. In many embodiments of the plurality of solid polymer particles disclosed herein, a particle from the plurality of particles has a compressive strength of at least 75 (in some embodiments, at least 85, 95, or 105) MPa and up to 120 or 125 MPa at a temperature of 120° C. In some embodiments of the plurality of solid polymer particles, substantially all of the particles in the plurality of solid polymer particles have a compressive strength of at least 75 (in some embodiments, at least 85, 95, or 105) MPa at a temperature of 120° C. Substantially all can mean, for example, at least 90, 95, or 99 percent of the particles in the plurality of solid polymer particles. In these embodiments, compressive strength is measured using an instrument available from Instron, Norwood, Mass., having load frame model 5967 50 kN, load cell model 2580-105 500 N and heat chamber 3119-605. The details of the evaluation are provided in the Examples, below.

In some embodiments of the plurality of solid polymer particles disclosed herein, a particle from the plurality of particles surprisingly has a compressive strength of at least 90 (in some embodiments, at least 100, 105, or 110) MPa and up to 200, 190, or 180 MPa at a temperature of 150° C. In some embodiments of the plurality of solid polymer particles, substantially all of the particles in the plurality of solid polymer particles surprisingly have a compressive strength of at least 90 (in some embodiments, at least 100, 105, or 110) MPa at a temperature of 150° C. In some of these embodiments, a maximum deformation at fracture of at least 50% (in some embodiments, at least 55% and even up to 65%) can be achieved. As shown in the Examples, below, this unexpected performance was achieved when at least one of the molecular weight between crosslinks was varied in the crosslinked network (e.g., by including two different types of epoxy: different classes and/or different epoxy equivalent weights) or when a non-aromatic chain was incorporated into the crosslinked network. Examples 10, 11, and 12 show that this unexpected performance can be achieved when two different types of epoxy resins are used in the preparation of the solid polymer particles. The two different types of epoxy resins can comprise either two different types of epoxy resin (e.g., a novolac and a bisphenol A type epoxy resin) or epoxy resins of the same type (e.g., bisphenol A type epoxy resins) but having different epoxy equivalent weights due to different levels of chain extension. Example 12 also demonstrates that a non-aromatic epoxy resin including a poly(oxyalkylene) can further improve the compression strength and maximum deformation.

Particles according to the present disclosure typically demonstrate high resistance to swelling in various solvents. For particles being used as proppants, resistance to swelling in various fluids (e.g., oil, xylene, toluene, methanol, carbon dioxide, and hydrochloric acid) is also a desirable product characteristic as excessive swelling and any degradation after exposure to such fluids can negatively impact the ability of the proppants to be injected into a fracture and the ability of the proppants to withstand the temperatures and pressures within the fracture. The plurality of solid polymer particles according to the present disclosure typically has high resistance to swelling in oil or condensate, aromatics (e.g., xylene and toluene), methanol, carbon dioxide, and hydrochloric acid. In many embodiments of the plurality of particles disclosed herein, a particle from the plurality of particles (at least some of the particles) swells not more than 30 (in some embodiments, not more than 25, 20, 15, or 10) percent by volume when submerged in toluene for 20 hours at 70° C. In some embodiments of the plurality of particles disclosed herein, any particle within the plurality of particles swells not more than 30 (in some embodiments, not more than 25, 20, 15, or 10) percent by volume when submerged in toluene for 20 hours at 70° C. In some embodiments of the plurality of solid polymer particles, substantially all of the particles in the plurality of particles may exhibit the indicated resistance to swelling in toluene. Substantially all can mean, for example, at least 90, 95, or 99 percent of the particles in the plurality of particles. For the purposes of the present disclosure, the percent volume swelling is determined by measuring the diameter of a sample of particles using a microscope. Details of the evaluation are provided in the Examples, below.

Crosslinked epoxies have been generally described as resins that may be useful for forming thermoset beads for use as proppants. See, for example, U. S. Pat. Appl. Pub. Nos. 2007/0021309 (Bicerano), 2007/0181302 (Bicerano), 2007/0066491 (Bicerano et al.), 2007/0161515 (Bicerano), and 2007/0144736 (Shinbach et al.). However, the art does not describe a plurality of particles made from aromatic epoxy crosslinked with a hardener comprising at least two amino groups and at least one of an aromatic ring or a cycloaliphatic ring. As shown in the Examples, below, the polymer particles according to the present disclosure have a high compression resistance relative to other crosslinked epoxy particles. For example, epoxies crosslinked with alkylene polyamine hardeners can be compressed with hand pressure, for example, using pliers. Therefore, the compressive strength of these particles is far inferior to the compressive strength of the plurality of particles according to the present disclosure. The compressive strength achieved by the plurality of particles according to the present disclosure is also surprisingly high when considering commercially available polymer proppant particles. For example, Comparative Examples A and B demonstrate that commercially available styrene—divinyl benzene beads have much lower compressive strength than the particles according to the present disclosure. Also, as reported in U.S. Pat. App. Pub. No. 2013/0126161 (Rule et al.), such commercially available proppants have much greater swelling in toluene (e.g., about 70 or 80 percent volume increase) than the particles according to the present disclosure when evaluated under comparable conditions. The level of resistance to swelling in toluene achieved by the plurality of particles according to the present disclosure is therefore surprisingly high when considering commercially available polymer proppant particles.

In some embodiments, the plurality of particles disclosed herein comprises at least one filler. Conventional fillers, which are typically inorganic fillers, may be useful for changing the mechanical properties (e.g., stiffness and compressive strength), resistance to solvent, or density of the solid polymer particles. When fillers are incorporated into the plurality of particles disclosed herein, typically the crosslinked aromatic epoxy remains the continuous phase throughout the particle. That is, the filler is typically incorporated into and surrounded by the continuous, crosslinked polymer matrix. In some embodiments, the crosslinked aromatic epoxy particles disclosed herein have up to 40, 35, 30, 25, or 20 percent by weight filler, based on the total weight of the particles. Typically, and surprisingly, we have found that the crosslinked aromatic epoxy particles disclosed herein have excellent compressive strength even in the absence of fillers. Accordingly, in some embodiments, the solid polymer particles according to the present disclosure are essentially free of fillers (in some embodiments, essentially free of inorganic filler). “Essentially free of fillers” (e.g., inorganic filler) can mean that the particles have no added fillers. “Essentially free of fillers” (e.g., inorganic filler) can also mean that the particles have filler at a level insufficient to significantly change the physical properties of the particles. For example, the solid polymer particles may comprise up to one (in some embodiments, 0.75, 0.5, 0.25, or 0.1) percent by weight of filler, based on the total weight of the particles.

The incorporation of fillers, among other techniques, may be useful for altering the density of a particle from the plurality of particles disclosed herein. In some embodiments, the density of the particles disclosed herein is in a range from 1.0 to 1.4 (in some embodiments, in a range from 1.0 to 1.3, 1.0 to 1.25, 1.1 to 1.2, or about 1.16) grams per cubic centimeter. The density of the particles in the plurality of particles may be adjusted to match the density of a fluid into which they are dispersed, for example, in a fracturing and propping operation. This allows the proppant particles to travel further into a fracture with minimal input of energy, which can result in a several-fold increase in effective fracture conductivity and accompanying enhanced oil recovery.

While the plurality of particles disclosed herein can include fillers in some embodiments, it should be understood that the particles comprising the crosslinked aromatic epoxy are not typically particles having a ceramic core coated with the crosslinked aromatic epoxy. In other words, the particles disclosed herein typically do not belong to the category of resin-coated proppants or resin-coated sand.

Instead, the particles disclosed herein may be understood to belong to the class of polymer beads or polymer proppants. The crosslinked aromatic epoxy polymer forms part of the core (which typically includes the geometric center) and the exterior of the particles. It may be understood that the polymer and optionally any fillers may be distributed throughout the particles typically uniformly. Thus, the term “solid” when referring to the solid polymer particles refers to particles having substantially the same composition throughout.

The term “solid” when referring to the solid polymer particles can also refer to the particles not containing hollows or pores. Thus, the solid polymer particles are typically non-porous. The term non-porous can mean that the solid polymer particles do not have pores that are greater than 100, 200, or 300 nanometers in size. The term non-porous can also mean that no pores are visible in the solid polymer particles using a scanning electron microscope available from Hitachi High Technologies America, Inc., Pleasanton, Calif., under the designation “TM3000” at a magnification of 100 times, 250 times, 500 times, 1000 times, or 2000 times. Porosity in a particle would tend to reduce the particles' compressive strength and the resistance to swelling in solvent. Thus, porosity is disadvantageous for particles being used as proppants.

Advantages of the plurality of particles disclosed herein include that they are relatively low in density yet provide relatively high compressive strength up to high temperatures and high resistance to swelling. Accordingly, the present disclosure provides a plurality of crosslinked epoxy particles each having a density of up to 1.4 grams per milliliter and a compressive strength measured at 150° C. of at least 90 megapascals. Because of their relatively low density, they can be used with lower viscosity, cheaper carrier fluids (described below). Their high compressive strength and high temperature performance renders them useful, for example, in fractures at depths of at least 500, 1000, 1500, 2000, 2500, 3000, 3500, 4000, 4500, or 5000 meters and at temperature in a range from 60° C. to 150° C., in some embodiments, 100° C. to 150° C. The plurality of particles disclosed herein may be useful as fracture proppants at depths, for example, up to 8000, 7500, 7000, 6500, or 6000 meters. These depths may correspond, for example, to closure pressures in a range from 500 psi to 15,000 psi (3.4×10⁷ Pa to 1.0×10⁸ Pa), in some embodiments, at least 8000 psi (5.5×10⁷ Pa).

The particles disclosed herein may, in some embodiments, comprise an impact modifier (e.g., an elastomeric resin or elastomeric filler). Examples of impact modifiers include polybutadiene, butadiene copolymers, polybutene, ground rubber, block copolymers, ethylene terpolymers, particles available, for example, from Akzo Nobel, Amsterdam, The Netherlands, under the trade designation “EXPANCEL”, EPDM rubber, and core-shell polymer particles. It is generally thought in the art that impact polymers may be useful for improving the properties of some thermoset polymer beads, for example, so that they do not undergo brittle failure in a fracture. However, in some embodiments, the crosslinked aromatic epoxy polymer is essentially free of an impact modifier. “Essentially free of an impact modifier” can mean that the particles have no added impact modifier, e.g., an elastomeric resin or elastomeric filler. “Essentially free of an impact modifier” can also mean that the particles have an impact modifier at a level insufficient to change the compression properties of the particles. For example, the crosslinked aromatic epoxy polymer may comprise up to one (in some embodiments, 0.75, 0.5, 0.25, or 0.1) percent by weight of an impact modifier, based on the total weight of the particles.

Typically, the plurality of particles according to the present disclosure comprises particles with a size in a range from 150 micrometers to 3000 micrometers (i.e., about 100 mesh to about 6 mesh (U.S. Standard Mesh)) (in some embodiments, in a range from 1000 micrometers to 3000 micrometers (i.e., about 18 mesh to about 6 mesh), 1000 micrometers to 2000 micrometers (i.e., about 18 mesh to about 10 mesh), 1000 micrometers to 1700 micrometers (i.e., about 18 mesh to about 12 mesh), 850 micrometers to 1700 micrometers (i.e., about 20 mesh to about 12 mesh), 850 micrometers to 1200 micrometers (i.e., about 20 mesh to about 16 mesh), 600 micrometers to 1200 micrometers (i.e., about 30 mesh to about 16 mesh), 425 micrometers to 850 micrometers (i.e., about 40 mesh to about 20 mesh), 300 micrometers to 600 micrometers (i.e., about 50 mesh to about 30 mesh), or about 150 micrometers to 600 micrometers (i.e., about 100 mesh to about 30 mesh). In some embodiments, at least 60%, 70%, 80%, or 90% by weight of the solid polymer particles have a size within one of these embodiment ranges. In some embodiments of the plurality of particles disclosed herein, any particle within the plurality of particles has a size that can be within one of these embodiment ranges. In some embodiments of the plurality of particles, substantially all of the particles in the plurality of particles can be within one of these embodiment size ranges. Substantially all can mean, for example, not more than 0.1 weight % of the particulates are larger than the larger size and not more than 2 or 1 weight % are smaller than the smaller size. The size of the plurality of particles is typically controlled by the stirring rate during suspension polymerization described above. High shear forces in the suspension result in smaller particle sizes. Desired graded fractions of the plurality of particles may be obtained using conventional classification techniques (e.g., sieving). The size of the particles desired may depend, for example, on the characteristics of a subterranean formation selected for a fracturing and propping operation. Particle size measurement is made by sieving the plurality of particles through a set of U.S. Standard mesh sieves. The weight of every fraction is measured.

The shape of the particles in the plurality of particles disclosed herein is typically at least somewhat spherical although the sphericity of the particles is not critical to this disclosure. The plurality of particles disclosed herein will typically meet or exceed the standards for sphericity and roundness as measured according to American Petroleum Institute Method RP56, “Recommended Practices for Testing Sand Used in Hydraulic Fracturing Operations”, Section 5, (Second Ed., 1995) (referred to herein as “API RP 56”). As used herein, the terms “sphericity” and “roundness” are defined as described in the API RP's and can be determined using the procedures set forth in the API RP's. In some embodiments, the sphericity of any particle in the plurality of particles is at least 0.6 (in some embodiments, at least 0.7, 0.8, or 0.9). In some embodiments, the roundness of any particle in the plurality of particles is at least 0.6 (in some embodiments, at least 0.7, 0.8, or 0.9).

The present disclosure provides plurality of mixed particles comprising the plurality of particles disclosed herein and other particles. The other particles may be conventional proppant materials such as at least one of sand, resin-coated sand, graded nut shells, resin-coated nut shells, sintered bauxite, particulate ceramic materials, glass beads, and particulate thermoplastic materials. Sand particles are available, for example, from Badger Mining Corp., Berlin, Wis.; Borden Chemical, Columbus, Ohio; Fairmont Minerals, Chardon, Ohio Thermoplastic particles are available, for example, from the Dow Chemical Company, Midland, Mich.; and Baker Hughes, Houston, Tex. Clay-based particles are available, for example, from CarboCeramics, Irving, Tex.; and Saint-Gobain, Courbevoie, France. Sintered bauxite ceramic particles are available, for example, from Borovichi Refractories, Borovichi, Russia; 3M Company, St. Paul, Minn.; CarboCeramics; and Saint Gobain. Glass beads are available, for example, from Diversified Industries, Sidney, British Columbia, Canada; and 3M Company. Generally, the sizes of other particles may be in any of the size ranges described above for the plurality of proppant particles disclosed herein. Mixing other particles (e.g., sand) and the plurality of particles disclosed herein may be useful, for example, for reducing the cost of proppant particles while maintaining at least some of the beneficial properties of the plurality of particles disclosed herein.

In some embodiments, the plurality of particles disclosed herein is dispersed in a fluid. The fluid may be a carrier fluid useful, for example, for depositing proppant particles into a fracture. A variety of aqueous and non-aqueous carrier fluids can be used with the plurality of particles disclosed herein. In some embodiments, the fluid comprises at least one of water, a brine, an alcohol, carbon dioxide (e.g., gaseous, liquid, or supercritical carbon dioxide), nitrogen gas, or a hydrocarbon. In some embodiments, the fluid further comprises at least one of a surfactant, rheological modifier, salt, gelling agent, breaker, scale inhibitor, dispersed gas, or other particles.

Illustrative examples of suitable aqueous fluids and brines include fresh water, sea water, sodium chloride brines, calcium chloride brines, potassium chloride brines, sodium bromide brines, calcium bromide brines, potassium bromide brines, zinc bromide brines, ammonium chloride brines, tetramethyl ammonium chloride brines, sodium formate brines, potassium formate brines, cesium formate brines, and any combination thereof. Rheological modifiers may be added to aqueous fluid to modify the flow characteristics of the fluid, for example. Illustrative examples of suitable water-soluble polymers that can be added to aqueous fluids include guar and guar derivatives such as hydroxypropyl guar (HPG), carboxymethylhydroxypropyl guar (CMHPG), carboxymethyl guar (CMG), hydroxyethyl cellulose (HEC), carboxymethylhydroxyethyl cellulose (CMHEC), carboxymethyl cellulose (CMC), starch based polymers, xanthan based polymers, and biopolymers such as gum Arabic, carrageenan, as well as any combination thereof. Such polymers may crosslink under downhole conditions. As the polymer undergoes hydration and crosslinking, the viscosity of the fluid increases, which may render the fluid more capable of carrying the proppant. Another class of rheological modifier is viscoelastic surfactants (“VES's”).

Examples of suitable non-aqueous fluids useful for practicing the present disclosure include alcohols (e.g., methanol, ethanol, isopropanol, and other branched and linear alkyl alcohols); diesel; raw crude oils; condensates of raw crude oils; refined hydrocarbons (e.g., gasoline, naphthalenes, xylenes, toluene and toluene derivatives, hexanes, pentanes, and ligroin); natural gas liquids; gases (e.g., carbon dioxide and nitrogen gas); liquid carbon dioxide; supercritical carbon dioxide; liquid propane; liquid butane; and combinations thereof. Some hydrocarbons suitable for use as such fluids can be obtained, for example, from SynOil, Calgary, Alberta, Canada under the trade designations “PLATINUM”, “TG-740”, “SF-770”, “SF-800”, “SF-830”, and “SF-840”. Mixtures of the above non-aqueous fluids with water (e.g., mixtures of water and alcohol or several alcohols or mixtures of carbon dioxide (e.g., liquid carbon dioxide) and water) may also be useful for practicing the present disclosure. Mixtures can be made of miscible or immiscible fluids. Rheological modifiers (e.g., a phosphoric acid ester) can be useful in non-aqueous fluids as well. In some of these embodiments, the fluid further comprises an activator (e.g., a source of polyvalent metal ions such as ferric sulfate, ferric chloride, aluminum chloride, sodium aluminate, and aluminum isopropoxide) for the gelling agent.

Fluid containing a plurality of particles according to the present disclosure dispersed therein can also include at least one breaker material (e.g., to reduce viscosity of the fluid once it is in the well). Examples of suitable breaker materials include enzymes, oxidative breakers (e.g., ammonium peroxydisulfate), encapsulated breakers such as encapsulated potassium persulfate (e.g., available, for example, under the trade designation “ULTRAPERM CRB” or “SUPERULTRAPERM CRB”, from Baker Hughes), and breakers described in U.S. Pat. No. 7,066,262 (Funkhouser).

Fluids having a plurality of particles according to the present disclosure dispersed therein may also be foamed. Foamed fluids may contain, for example, nitrogen, carbon dioxide, or mixtures thereof at volume fractions ranging from 10% to 90% of the total fluid volume.

The fluids described above, in any of their embodiments, may be useful, for example, for practicing the method of fracturing a subterranean geological formation penetrated by a wellbore according to the present disclosure. Techniques for fracturing subterranean geological formations comprising hydrocarbons are known in the art, as are techniques for introducing proppants into the fractured formation to prop open fracture openings. In some methods, a fracturing fluid is injected into the subterranean geological formation at rates and pressures sufficient to open a fracture therein. When injected at the high pressures exceeding the rock strength, the fracturing fluid opens a fracture in the rock. The fracturing fluid may be an aqueous or non-aqueous fluid having any of the additives described above. Particles described herein can be included in the fracturing fluid. That is, in some embodiments, injecting the fracturing fluid and introducing the plurality of particles are carried out simultaneously. In other embodiments, the plurality of particles disclosed herein may be present in a second fluid (described in any of the above embodiments) that is introduced into the well after the fracturing fluid is introduced. As used herein, the term “introducing” (and its variants “introduced”, etc.) includes pumping, injecting, pouring, releasing, displacing, spotting, circulating, or otherwise placing a fluid or material (e.g., proppant particles) within a well, wellbore, fracture or subterranean formation using any suitable manner known in the art. The plurality of particles according to the present disclosure can serve to hold the walls of the fracture apart after the pumping has stopped and the fracturing fluid has leaked off or flowed back. The plurality of particles according to the present disclosure may also be useful, for example, in fractures produced by etching (e.g., acid etching). Fracturing may be carried out at a depth, for example, in a range from 500 to 8000 meters, 1000 to 7500 meters, 2500 to 7000 meters, or 2500 to 6000 meters. In some embodiments, fracturing is carried out at a temperature in a range from 100° C. to 150° C. In some embodiments, after fracturing, the fracture has a closure pressure greater than 55 MPa (8000 psi).

The carrier fluid carries particles into the fractures where the particles are deposited. If desired, particles might be color coded and injected in desired sequence such that during transmission of subject fluid therethrough, the extracted fluid can be monitored for presence of particles. The presence and quantity of different colored particles might be used as an indicator of what portion of the fractures are involved as well as indicate or presage possible changes in transmission properties.

### Some Embodiments of the Disclosure

In a first embodiment, the present disclosure provides a plurality of solid polymer particles comprising a multifunctional aromatic epoxy crosslinked with a hardener comprising at least two amino groups and at least one of an aromatic ring or a cycloaliphatic ring, wherein in the plurality of solid polymer particles substantially all of the solid polymer particles have a size in a range from 150 micrometers to 3000 micrometers.

In a second embodiment, the present disclosure provides a plurality of solid polymer particles comprising a multifunctional aromatic epoxy crosslinked with a hardener comprising at least two amino groups and at least one of an aromatic ring or a cycloaliphatic ring, wherein in the plurality of solid polymer particles at least 90% by weight of the solid polymer particles have a size in a range from 150 micrometers to 3000 micrometers.

In a third embodiment, the present disclosure provides a plurality of solid polymer particles comprising a multifunctional aromatic epoxy crosslinked with a hardener comprising at least two amino groups and at least one of an aromatic ring or a cycloaliphatic ring for use as proppants.

In a fourth embodiment, the present disclosure provides a plurality of solid polymer particles according to any one of the first to third embodiments, wherein a particle from the plurality of solid polymer particles has a compressive strength of at least 45 megapascals at a temperature of 150° C.

In a fifth embodiment, the present disclosure provides a plurality of solid polymer particles comprising a multifunctional aromatic epoxy crosslinked with a hardener comprising at least two amino groups and at least one of an aromatic ring or a cycloaliphatic ring wherein a particle in the plurality of solid polymer particles has a compressive strength measured at 150° C. of at least 90 megapascals.

In a sixth embodiment, the present disclosure provides a plurality of crosslinked epoxy particles each having a density of up to 1.4 grams per milliliter and a compressive strength measured at 150° C. of at least 90 megapascals.

In a seventh embodiment, the present disclosure provides a plurality of solid polymer particles according to any one of the first to sixth embodiments, wherein the crosslinked aromatic epoxy comprises a novolac epoxy.

In an eighth embodiment, the present disclosure provides a plurality of solid polymer particles according to any one of the first to seventh embodiments, wherein the crosslinked aromatic epoxy comprises a crosslinked bisphenol diglycidyl ether.

In a ninth embodiment, the present disclosure provides a plurality of solid polymer particles according to any one of the first to eighth embodiments, wherein at least some of the solid polymer particles have a crosslinked network in which a molecular weight between crosslinks varies.

In a tenth embodiment, the present disclosure provides a plurality of solid polymer particles according to any one of the first to ninth embodiments, wherein the crosslinked aromatic epoxy comprises at least two different epoxies.

In an eleventh embodiment, the present disclosure provides a plurality of solid polymer particles according to any one of the first to tenth embodiments, wherein the crosslinked aromatic epoxy comprises epoxies having at least two different epoxy equivalent weights.

In a twelfth embodiment, the present disclosure provides a plurality of solid polymer particles according to any one of the first to tenth embodiments, wherein the crosslinked aromatic epoxy further comprises a non-aromatic epoxy.

In a thirteenth embodiment, the present disclosure provides a plurality of solid polymer particles according to the twelfth embodiments, wherein the non-aromatic epoxy comprises a polyoxyalkylene.

In a fourteenth embodiment, the present disclosure provides a plurality of solid polymer particles according to any one of the first to thirteenth embodiments, wherein the hardener comprises an aromatic ring.

In a fifteenth embodiment, the present disclosure provides a plurality of solid polymer particles according to the fourteenth embodiment, wherein the hardener comprises at least one of a phenylenediamine a diethyl toluene diamine, a diamino toluene, 1,2-diamino-3,5-dimethylbenzene, 4,5-dimethyl-1,2-phenylenediamine, 2,4,6-trimethyl-m-phenylenediamine, 2,3,5,6-tetramethyl-p-phenylenediamine, a aminobenzylamine, ethylenedianiline, 2,2′-biphenyldiamine, diaminodiphenylmethane, diaminodiphenylsulfone, a halogenated substituted phenylene diamine, a xylylenediamine, or 4-(2-aminoethyl)aniline.

In a sixteenth embodiment, the present disclosure provides a plurality of solid polymer particles according to any one of the first to thirteenth embodiments, wherein the hardener comprises a cycloaliphatic ring.

In a seventeenth embodiment, the present disclosure provides a plurality of solid polymer particles according to any one of the first to fourteenth embodiments, wherein the crosslinked aromatic epoxy is essentially free of inorganic filler.

In an eighteenth embodiment, the present disclosure provides a plurality of solid polymer particles according to any one of the first to seventeenth embodiments, wherein the particles are essentially free of a polyolefin comprising pendent carboxylic acid, carboxylic acid anhydride, amide, and carboxylic acidimide groups.

In a nineteenth embodiment, the present disclosure provides a plurality of solid polymer particles according to any one of the first to eighteenth embodiments, wherein a particle from the plurality of solid polymer particles swells not more than 30 percent by volume when submerged in toluene for 20 hours at 70° C.

In a twentieth embodiment, the present disclosure provides a plurality of solid polymer particles according to any one of the first to nineteenth embodiments, wherein a particle from the plurality of solid polymer particles has a compressive strength of at least 110 megapascals at a temperature of 150° C.

In a twenty-first embodiment, the present disclosure provides a plurality of solid polymer particles according to any one of the first to twentieth embodiments, wherein a particle from the plurality of solid polymer particles has a maximum deformation at fracture of at least 50%.

In a twenty-second embodiment, the present disclosure provides a plurality of solid polymer particles according to any one of the first to twenty-first embodiments, wherein a particle from the plurality of solid polymer particles has a density in a range from 1.0 to 1.4 grams per cubic centimeter.

In a twenty-third embodiment, the present disclosure provides a plurality of mixed particles comprising the plurality of particles according to any one of the first to twenty-second embodiments and other particles.

In a twenty-fourth embodiment, the present disclosure provides the plurality of mixed particles according to the twenty-third embodiment, wherein the other particles comprise at least one of sand, resin-coated sand, graded nut shells, resin-coated nut shells, sintered bauxite, particulate ceramic materials, glass beads, and particulate thermoplastic materials.

In a twenty-fifth embodiment, the present disclosure provides the plurality of mixed particles according to the twenty-third embodiment, wherein the other particles comprise at least one of sand or resin-coated sand.

In a twenty-sixth embodiment, the present disclosure provides a fluid comprising a plurality of particles according to any one of embodiments 1 to 22 or the plurality of mixed particles according to any one of embodiments 23 to 25 dispersed therein.

In a twenty-seventh embodiment, the present disclosure provides a fluid according to the twenty-sixth embodiment, wherein the fluid comprises at least one of water, a brine, an alcohol, carbon dioxide, nitrogen gas, or a hydrocarbon.

In a twenty-eighth embodiment, the present disclosure provides a fluid according to the twenty-sixth or twenty-seventh embodiment, further comprising at least one of a surfactant, rheological modifier, salt, gelling agent, breaker, scale inhibitor, or dispersed gas.

In a twenty-ninth embodiment, the present disclosure provides a method of fracturing a subterranean geological formation penetrated by a wellbore, the method comprising:

injecting into the wellbore penetrating the subterranean geological formation a fracturing fluid at a rate and pressure sufficient to form a fracture therein; and

introducing into the fracture a plurality of solid polymer particles according to any one of the first to twenty-second embodiments, a plurality of mixed particles according to any one of the twenty-third to twenty-fifth embodiments, or a fluid according to any one of the twenty-sixth to twenty-eighth embodiments.

In a thirtieth embodiment, the present disclosure provides a method according to the twenty-ninth embodiment, wherein injecting the fracturing fluid and introducing the plurality of particles are carried out simultaneously, and wherein the fracturing fluid comprises the plurality of particles.

In a thirty-first embodiment, the present disclosure provides a method according to the twenty-ninth or thirtieth embodiment, wherein the fracturing is carried out at a depth of at least 500 meters.

In a thirty-second embodiment, the present disclosure provides a method according to any one of the twenty-ninth to thirty-first embodiments, wherein the fracturing is carried out at a temperature in a range from 100° C. to 150° C.

In a thirty-third embodiment, the present disclosure provides a method according to any one of the twenty-ninth to thirty-second embodiments, wherein after fracturing, the fracture has a closure pressure greater than 55 MPa (8000 psi).

In a thirty-fourth embodiment, the present disclosure provides a method of making a plurality of solid polymer particles according to any one of the first to twenty-second embodiments, the method comprising:

providing a mixture comprising an aromatic epoxy resin having at least two epoxy functional groups and a hardener comprising at least two amino groups and at least one of an aromatic ring or a cycloaliphatic ring;

suspending the mixture in a solution comprising water to form a suspension; and

initiating crosslinking of the aromatic epoxy resin to make the plurality of solid polymer particles.

In a thirty-fifth embodiment, the present disclosure provides a method according to the thirty-fourth embodiment, wherein the solution comprising water further comprises at least one of a cellulose polymer, gelatin, polyvinylalcohol, partially hydrolyzed polyvinyl alcohol, an acrylic acid or methacrylic acid polymer, a poly(styrene sulfonate), talc, hydroxyapatite, barium sulfate, kaolin, magnesium carbonate, magnesium hydroxide, calcium phosphate, or aluminum hydroxide as a suspending agent.

In a thirty-sixth embodiment, the present disclosure provides a method according to the thirty-fourth embodiment, wherein the solution comprising water is essentially free of a polyolefin comprising pendent carboxylic acid, carboxylic acid anhydride, amide, and carboxylic acidimide groups. In a thirty-seventh embodiment, the present disclosure provides a method according to the thirty-fourth embodiment, wherein the solution comprising water further comprises a cellulose polymer.

In a thirty-eighth embodiment, the present disclosure provides a method according to any one of the thirty-fourth to thirty-seventh embodiments, further comprising:

separating the plurality of particles from the solution comprising water; and

subjecting the plurality of particles to post-polymerization heating at a temperature of at least 100° C.

In a thirty-ninth embodiment, the present disclosure provides a method according to any one of the thirty-fourth to thirty-eighth embodiments, further comprising pre-reacting the aromatic epoxy resin and the hardener before suspending the mixture in the solution comprising water.

In a fortieth embodiment, the present disclosure provides a method according to any one of the thirty-fourth to thirty-ninth embodiments, wherein the plurality of solid polymer particles is essentially free of volatile organic solvent.

In a forty-first embodiment, the present disclosure provides a method according to any one of the thirty-fourth to fortieth embodiments, wherein the mixture comprises at least two different epoxy resins.

In a forty-second embodiment, the present disclosure provides a method according to the forty-first embodiments, wherein the at least two different epoxy resins have different epoxy equivalent weights.

In a forty-third embodiment, the present disclosure provides a method according to the forty-first or forty-second embodiments, wherein the at least two different epoxy resins comprise a bisphenol A glycidyl ether resin and a novolac epoxy resin.

In a forty-fourth embodiment, the present disclosure provides a method according to any one of the forty-first to forty-third embodiments, wherein the at least two different epoxy resins comprise a non-aromatic epoxy resin.

In a forty-fifth embodiment, the present disclosure provides a method according to the forty-fourth embodiment, wherein the non-aromatic epoxy comprises a polyoxyalkylene.

In order that this disclosure can be more fully understood, the following examples are set forth. It should be understood that these examples are for illustrative purposes only, and are not to be construed as limiting this disclosure in any manner.

### EXAMPLES

In these examples, all percentages, proportions and ratios are by weight unless otherwise indicated. These abbreviations are used in the following examples: g=gram, min=minutes, in=inch, m=meter, cm=centimeter, mm=millimeter, and mL=milliliter.

### Materials

“D.E.R. 330” is a trade designation for a liquid epoxy resin that is a reaction product of epichlorhydrin and bisphenol A with epoxide equivalent weight of 176-185 g/equivalent, commercially available from Dow Chemical, Midland, Mich.

“D.E.R. 332” is a trade designation for a high purity bisphenol A diglycidyl ether with epoxide equivalent weight of 172-176 g/equivalent, commercially available from Dow Chemical.

“D.E.R. 661” is a trade designation of a low molecular weight solid epoxy resin product from the reaction between epichlorohydrin and bisphenol A, commercially available from Dow Chemical. The manufacturer indicates that it has an epoxide equivalent weight equal to 500-560 g/equivalent.

“D.E.R. 736” is the trade designation of a liquid epoxy resin product of reaction of epiclorohydrin and dipropylene glycol. It is a low viscosity, light color epoxy resin commercially available from Dow Chemical. The manufacturer indicates that it has an epoxide equivalent weight equal to 175-205 g/equivalent.

“D.E.N. 425” is a trade designation for an epoxy novolac resin. A liquid reaction product of epichlorohydrin and phenol-formaldehyde novolac. The product is available from Dow Chemical, Midland, Mich. The manufacturer indicates that it has an epoxide equivalent weight equal to 169-175 g/eq and a multi-functionality of +/−2.5 epoxy groups.

“D.E.N. 431” is a trade designation for a semi-solid product made from epiclorohydrin and phenol-formaldehyde novolac. The product is available from Dow Chemical, Midland, Mich. The manufacturer indicates that it has an epoxide equivalent weight equal to 172-179 g/eq and a multi-functionality of +/−2.8 epoxy groups.

“D.E.N. 438” is a trade designation for a semi-solid product made from epiclorohydrin and phenol-formaldehyde novolac. The product is available from Dow Chemical, Midland, Mich. The manufacturer indicates that it has an epoxide equivalent weight equal to 176-181 g/eq and a multi-functionality of +/−3.6 epoxy groups.

“LONZACURE DETDA 80” is a trade designation for a liquid aromatic diamine, commercially available from Lonza, Basel, Switzerland, containing a mixture of isomers of diethylmethylbenzenediamine (80% of 3,5-diethyltoluene-2,4 diamine and 20% of 3,5-diethyltoluene-2,6-diamine) with purity >97% according to the manufacturer. The product was not further purified or treated.

Hydroxyethyl cellulose (HEC) was supplied by Sigma-Aldrich with a My of about 90,000. The product was used as a stabilizing agent for the beads during suspension polymerization. Isophoronediamine is a cycloaliphatic diamine (5-amino-1,3,3-trimethylcyclohexanemethylamine); a mixture of cis and trans isomers supplied by Sigma-Aldrich with 99% purity was used as received.

“JEFFAMINE D230” is a polyetheramine supplied by Huntsman Chemical, The Woodlands, Tex. The diamine has a repeating oxypropylene unit with primary amine functional groups located at both ends of the chain on secondary carbon atoms and has an average molecular weight of 230 g/mol.

### Test Methods:

### Compression:

Single epoxy beads were tested in compression using an Instron tester (Norwood, Mass., load frame model 5967 50 kN, load cell model 2580-105 500 N and heat chamber 3119-605. Software Bluehill 2). The compression rate was 0.13 cm (0.05 in)/min. For Examples 1 to 3 and Comparative Examples A and B, epoxy beads with diameter of 0.18 cm (0.07 in) using a tolerance of +/−0.025 mm (0.001 in) were used for the test. For Examples, 4 to 12, epoxy beads with diameter of 0.13 cm (0.05 in) using a tolerance of +/−0.025 mm (0.001 in) were used for the test. A caliper was used to perform these measurements. Tests were individually carried out 150° C. or at a lower temperature indicated in the Table, below. Readings of load versus percentage of deformation were obtained. Microscopic photographs (model “SteREO Lumar V12” commercially available from Carl Zeiss, Oberkochen, Germany) at a magnification of 25× were taken from the beads after the test. In all cases the beads exhibited no fragmentation (shattering) at any of the compression and temperature conditions used as indicated in the Tables. The compressive strength was calculated using the load applied at the point of fracture and the initial cross-sectional area of the particle under testing. Max deformation (%) refers to the maximum deformation of the particle before fracturing.

### Density:

Density was measured by immersion of the beads in distilled water at room temperature using a 50 mL pycnometer (Blaubrand® Borosilicate glass 3.3 Guy-Lussac type, 50 mL) and a balance with 0.1 mg precision.

### Swelling Evaluation:

Swelling was measured using the change in volume of the beads (five beads were measured) before and after soaking in the different solvents as indicated in the tables. Beads were immersed in either toluene, xylene, 80% methanol/20% water or 28% hydrochloric acid at 70° C. for 20 hours. The diameter change in the size of the beads was measured using a microscope (model “SteREO Lumar V12” commercially available from Carl Zeiss, Oberkochen, Germany) with 30× or 40× magnification. The difference in diameter was used to calculate % volume increase in each sample.

### General Method of Suspension Polymerization for Synthesis of Epoxy Beads:

The mixture of epoxy resin and hardener (with or without precuring) is added to a volume of water and stabilizing agent under mechanical stirring using a Caframo (Georgian Bluffs, Ontario, Calif.) stainless steel blade (Model A131, high torque overhead stirrer BDC3030). Water was previously heated to 90° C. using a recirculating bath in a one liter double jacket glass reactor. The stirrer rate was kept constant (150-200 rpm) to form and maintain the beads in suspension. Hydroxyethyl cellulose (HEC) was used as stabilizing agent. HEC was previously dissolved in water at a concentration of 5.0 g/l. The system was maintained at constant temperature as described in examples and stirring for 3-5 hrs. Subsequently, the recirculation bath was cooled down to 25-30° C. under stirring. The beads were decanted, filtered and rinsed using treated water. Different post-curing conditions were evaluated by introducing the beads in an oven under air at specific curing times and temperatures.

### Comparative Examples A and B

Commercially available proppant (Comparative Example A, trade designation “FRACBLACK”, 0.050 inch diameter, available from Sun Drilling Products Corp., Belle Chasse, La.) along with 0.050 inch styrene-divinyl benzene beads (SDVB, Comparative Example B, beads with 5% divinyl benzene from Anhui Sanxing, Anhui, China) were separately compression tested at 150° C. with results in Table 1 below.

TABLE 1

| | Stress @ | Stress @ | Stress @ | Stress @ | Compressive | |
|---|---|---|---|---|---|---|
| | 10% | 20% | 30% | 40% | Strength | Max |
| | MPa (psi) | MPa (psi) | MPa (psi) | MPa (psi) | MPa (psi) | Deformation % |
| Comparative | 0.0188 | 0.50 | 1.21 | 2.20 | — | Continuous |
| Example A | (2.73) | (72.02) | (175.5) | (318.9) | | deformation |
| Comparative | 0.55 | 1.499 | 3.42 | 8.56 | 24.91 | 55.6 |
| Example B | (79.30) | (217.4) | (496.6) | (1241) | (3981) | |

### Example 1

### Synthesis of Epoxy Beads Using “D.E.R. 330”

23.20 g of “D.E.R 330” was weighed into a plastic beaker. A stoichiometric amount of “LONZACURE DETDA 80” (5.82 g) was then added to the beaker and mixed well using a stainless steel spatula. The mixture was added to one liter double jacketed glass reactor that contained 1 liter of water and 5.0 g/l of hydroxyl ethyl cellulose at 90° C. under stirring at 150 rpm using a Caframo (Georgian Bluffs, Ontario, Calif.) stainless steel blade (Model A131, high torque overhead stirrer BDC3030). After 5 hrs, the reactor was cooled down to 20° C. The epoxy beads were decanted, rinsed, filtered, and rinsed using treated water. The beads were transferred to an aluminum dish and left to dry overnight at 20° C. Samples were placed in an oven and sequentially ramp postcured to the final temperatures as per Table 2. The variously postcured beads were then compression tested (Tables 3 and 4) and density and swell tested (Table 5).

TABLE 2
Post cure conditions

| | 90° C. | 110° C. | 130° C. | 150° C. | 170° C. | 190° C. |
|---|---|---|---|---|---|---|
| EX1A | 3 hrs | 2 hrs | 2 hrs | 2 hrs | | |
| EX1B | 3 hrs | 2 hrs | 2 hrs | 2 hrs | 2 hrs | |
| EX1C | 3 hrs | 2 hrs | 2 hrs | 2 hrs | 2 hrs | 2 hrs |

TABLE 3
Compression Testing of Postcured Beads at 120° C.

| | Final Cure | Stress @ | Stress @ | Stress @ | Stress @ | Compressive | |
|---|---|---|---|---|---|---|---|
| | Temp | 10% | 20% | 30% | 40% | Strength | Max |
| | (° C.) | MPa (psi) | MPa (psi) | MPa (psi) | MPa (psi) | MPa (psi) | Deformation % |
| EX1A | 150 | 5.67 (822) | 10.02 (1454) | 14.53 (2108) | 27.00 (3916) | 107.99 (15663) | 56.7 |
| EX1B | 170 | 10.38 (1505) | 17.01 (2467) | 24.94 (3617) | 41.56 (6028) | 79.496 (11530) | 51.4 |
| EX1C | 190 | 11.00 (1595) | 18.82 (2730) | 26.38 (3826) | 44.13 (6401) | 94.403 (13692) | 50.6 |

TABLE 4
Compression Testing of Postcured Beads at 150° C.

| | Final Cure | Stress @ | Stress @ | Stress @ | Stress @ | Compressive | |
|---|---|---|---|---|---|---|---|
| | Temp | 10% | 20% | 30% | 40% | Strength | Max |
| | (° C.) | MPa (psi) | MPa (psi) | MPa (psi) | MPa (psi) | MPa (psi) | Deformation % |
| EX1A | 150 | 2.76 (400) | 5.07 (735) | 8.68 (1259) | 19.47 (2824) | 64.93 (9418) | 51.5 |
| EX1B | 170 | 6.35 (921) | 10.34 (1500) | 16.51 (2395) | 33.97 (4927) | 50.55 (7331) | 44.3 |
| EX1C | 190 | 11.85 (1718) | 19.41 (2815) | 27.25 (3953) | 45.24 (6562) | 65.24 (9462) | 45.8 |

TABLE 5
Density and Swell Testing

| | | % | % | % Volume | % |
|---|---|---|---|---|---|
| | | Volume | Volume | Change (80:20 | Volume |
| | Density | Change | Change | methanol/ | Change |
| | (g/mL) | (toluene) | (xylenes) | water) | (28% HCl) |
| EX1A | 1.161 | 27 | 4 | 15 | 4 |
| EX1B | 1.160 | 14 | 5 | 14 | 6 |
| EX1C | 1.158 | 15 | 5 | 10 | 7 |

### Example 2

### Synthesis of Epoxy Beads Using “D.E.R. 330” (Precured Resin)

23.20 g of “D.E.R. 330” was weighed into a polymethylpentene beaker. A stoichiometric amount of “LONZACURE DETDA 80” (5.82 g) was added and mixed well with a stainless steel spatula. The mixture was placed in a silicone oil bath at 120° C. and stirred at 150 rpm using a Petite Digital Caframo overhead stirrer Model BDC 250. The sample reached 107° C. after 40 min after which it was then removed from the hot bath (precuring time). The precured mixture was transferred to a one liter double jacketed glass reactor containing 500 ml water and 2.5 g HEC in solution, stirring at 200 rpm Caframo (Georgian Bluffs, Ontario, Calif.) stainless steel blade (Model A131, high torque overhead stirrer BDC3030) and preheated to 90° C. using a Julabo heating bath with mineral oil. The reactor temperature was set to 30° C. after 4 hrs. Epoxy beads obtained were decanted, rinsed, filtered and rinsed using treated water. Sample was dried at 20° C. Samples were placed in an oven and sequentially ramp postcured to the final temperatures as per Table 6. The variously postcured beads were then compression tested (Tables 7 and 8).

TABLE 6
Post cure conditions

| | 90° C. | 110° C. | 130° C. | 150° C. | 170° C. | 190° C. |
|---|---|---|---|---|---|---|
| EX2A | 1 hr | 2 hrs | 2 hrs | 2 hrs | | |
| EX2B | 1 hr | 2 hrs | 2 hrs | 2 hrs | 2 hrs | |
| EX2C | 1 hr | 2 hrs | 2 hrs | 2 hrs | 2 hrs | 2 hrs |

TABLE 7
Compression Testing of Postcured Beads at 120° C.

| | Final Cure | Stress @ | Stress @ | Stress @ | Stress @ | Compressive | |
|---|---|---|---|---|---|---|---|
| | Temp | 10% | 20% | 30% | 40% | Strength | Max |
| | (° C.) | MPa (psi) | MPa (psi) | MPa (psi) | MPa (psi) | MPa (psi) | Deformation % |
| EX2A | 150 | 16.14 (2341) | 24.28 (3522) | 32.03 (4646) | 54.73 (7938) | 108.39 (15721) | 49.2 |
| EX2B | 170 | 15.40 (2234) | 24.64 (3574) | 34.48 (5001) | 60.94 (8839) | 97.84 (14190) | 46.4 |
| EX2C | 190 | 16.32 (2367) | 26.09 (3784) | 36.43 (5290) | 63.71 (9240) | 94.05 (13641) | 45.6 |

TABLE 8
Compression Testing of Postcured Beads at 150° C.

| | Final Cure | Stress @ | Stress @ | Stress @ | Stress @ | Compressive | |
|---|---|---|---|---|---|---|---|
| | Temp | 10% | 20% | 30% | 40% | Strength | Max |
| | (° C.) | MPa (psi) | MPa (psi) | MPa (psi) | MPa (psi) | MPa (psi) | Deformation % |
| EX2A | 150 | 11.37 (1649) | 16.24 (2355) | 24.55 (3561) | 48.67 (7059) | 85.89 (12458) | 46.7 |
| EX2C | 190 | 12.87 (1866) | 19.88 (2883) | 30.94 (4487) | 60.90 (8833) | 73.98 (10730) | 42.5 |

### Example 3

### Synthesis of Epoxy Beads Using “D.E.R. 332” (Precured Resin with Excess Amine)

23.2 g of “D.E.R. 332” was weighed into a polymethylpentene beaker and 7.38 g of “LONZACURE DETDA 80” was added (25% excess of the stoichiometric amount). This was mixed well using a stirrer (Petite Digital Caframo overhead stirrer Model BDC 250) at 480 rpm for 10 min. The mixture was then placed in a silicone oil bath at 115° C. and stirred at 180 rpm. The sample was removed from the hot bath after 20 min (precuring time). The precured mixture was transferred to the reactor a one liter double jacketed glass reactor containing 500 ml water and 2.5 g HEC in solution, stirring at 180 rpm Caframo (Georgian Bluffs, Ontario, Calif.) stainless steel blade (Model A131, high torque overhead stirrer BDC3030) and preheated to 90° C. using a Julabo heating bath with mineral oil. The reactor temperature was set to 30° C. after 5 hours. Epoxy beads obtained were decanted, rinsed, filtered and rinsed using treated water. Sample was dried at 20° C. The sample was placed in an oven and sequentially ramp postcured to 150° C. as per Table 9. The postcured beads were then compression tested (Tables 10 and 11).

Epoxy beads from Example 3 were observed under a scanning electron microscope obtained from Hitachi High Technologies America, Inc., under the designation “TM3000” at a magnification of 100 times, 500 times, and 2000 times. A smooth surface was observed, and no pores were observed at any of these magnifications.

### Example 4

### Synthesis of Epoxy Beads Using “D.E.N. 425” and Excess Diamine

35.72 g of “D.E.N 425” was weighed into a polymethylpentene beaker and 11.93 g of “LONZACURE DETDA 80” was added (25% excess of the stoichiometric amount). This was mixed using a Petite Digital Caframo overhead stirrer Model BDC 250 at 480 rpm for 10 min. The mixture was then placed in a silicone oil bath at 115° C. and stirred at 480 rpm (Petite Digital Caframo overhead stirrer Model BDC 250). The sample was removed from the hot bath after 23 min (precuring time). The precured mixture was transferred to the reactor (double jacketed glass reactor, 1 liter capacity) containing 500 ml water and 2.5 g HEC in solution, stirring at 200 rpm and preheated to 90° C. using a Julabo heating bath with mineral oil. The reactor temperature was set to 30° C. after 4 hours. Epoxy beads obtained were decanted, rinsed, filtered and rinsed using treated water. Sample was dried at 20° C. The sample was placed in an oven and sequentially ramp postcured to 150° C. as per Table 9. The postcured beads were then compression tested (Table 10 and 11). Beads of 0.050+/−0.005 inches in diameter were selected for compression testing. Density and swell testing are indicated in Table 12.

### Example 5

### Synthesis of Epoxy Beads Using “D.E.N. 425” and Stoichiometric Diamine

35.73 g of “D.E.N. 425” was weighed into a polymethylpentene beaker and 9.55 g of LONZACURE DETDA 80″ was added (stoichiometric amount). This was mixed using a Petite Digital Caframo® overhead stirrer Model BDC 250 at 480 rpm for 10 min. The mixture was then placed in a silicone oil bath at 122° C. and stirred at 480 rpm (Petite Digital Caframo overhead stirrer Model BDC 250). The sample was removed from the hot bath after 20 min (precuring time). The precured mixture was transferred to the reactor (double jacketed glass reactor, 1 liter capacity) containing 500 ml water and 2.5 g HEC in solution, stirring at 200 rpm and preheated to 95° C. using a Julabo heating bath with mineral oil. The reactor temperature was set to 25° C. after 4 hours. Epoxy beads obtained were decanted, rinsed, filtered and rinsed using treated water. Sample was dried at 20° C. The sample was placed in an oven and sequentially ramp postcured to 150° C. as per Table 9. The postcured beads were then compression tested as per Table 10 and 11 and density and swell tested per Table 12. Beads of 0.050+/−0.005 inches in diameter were selected for compression testing.

### Example 6

### Synthesis of Epoxy Beads Using “D.E.N. 431” and Stoichiometric Diamine

36.05 g of “D.E.N 431” was weighed into a polymethylpentene beaker and 9.45 g of LONZACURE DETDA 80″ was added (stoichiometric amount). This was mixed well using Petite Digital Caframo overhead stirrer Model BDC 250 at 480 rpm for 10 min. The mixture was then placed in a silicone oil bath at 120° C. and stirred at 480 rpm (Petite Digital Caframo overhead stirrer Model BDC 250). The sample was removed from the hot bath after 20 min (precuring time). The precured mixture was transferred to the reactor (double jacketed glass reactor, 1 liter capacity) containing 500 ml water and 2.5 g HEC in solution, stirring at 200 rpm and preheated to 95° C. using a Julabo heating bath with mineral oil. The reactor temperature was set to 30° C. after 3.5 hours. Epoxy beads obtained were decanted, rinsed, filtered and rinsed using treated water. Sample was dried at 20° C. The sample was placed in an oven and sequentially ramp postcured to 150° C. as per Table 9. The postcured beads were then compression tested as per Table 10 and 11 and density and swell tested per Table 12. Beads of 0.050+/−0.005 inches in diameter were selected for compression testing.

### Example 7

### Synthesis of Epoxy Beads Using “D.E.N. 438” and Stoichiometric Diamine

28.35 g of “D.E.N 438” was weighed into a polymethylpentene beaker. The beaker was placed in a silicone oil bath and heated up to 95° C. to decrease viscosity. 7.29 g of LONZACURE DETDA 80″ were added (stoichiometric amount) and heating was continued while stirring at 480 rpm using a Petite Digital Caframo overhead stirrer Model BDC 250. The mixture was removed from the hot bath after 15 min (precuring time). The precured mixture was transferred to a reactor (double jacketed glass reactor, 1 liter capacity) containing 500 ml water and 2.5 g HEC in solution, stirring at 300 rpm and preheated to 95° C. using a Julabo heating bath with mineral oil. The reactor temperature was set to 30° C. after 3.5 hours. Epoxy beads obtained were decanted, rinsed, filtered and rinsed using treated water. Sample was dried at 20° C. The sample was placed in an oven and sequentially ramp postcured to 150° C. as per Table 9. The postcured beads were then compression tested as per Table 10 and 11 and density and swell tested per Table 12. Beads of 0.050+/−0.005 inches in diameter were selected for compression testing.

TABLE 9
Post cure conditions

| | 90° C. | 110° C. | 130° C. | 150° C. |
|---|---|---|---|---|
| EX3 | 1 hr | 2 hrs | 2 hrs | 2 hrs |
| EX4 | 1 hr | 1 hr | 1 hr | 2 hrs |
| EX5 | 1 hr | 1 hr | 1 hr | 2 hrs |
| EX6 | 1 hr | 1 hr | 1 hr | 2 hrs |
| EX7 | 1 hr | 1 hr | 1 hr | 2 hrs |

TABLE 10
Compression Testing of Postcured Beads at 120° C.

| | Final | | | | | | |
|---|---|---|---|---|---|---|---|
| | Cure | Stress @ | Stress @ | Stress @ | Stress @ | Compressive | |
| | Temp | 10% | 20% | 30% | 40% | Strength | Max |
| | (° C.) | MPa (psi) | MPa (psi) | MPa (psi) | MPa (psi) | MPa (psi) | Deformation % |
| EX3 | 150 | 15.92 | 23.88 | 29.97 | 47.75 | 125.82 | 53.9 |
| | | (2309) | (3463) | (4347) | (6926) | (18249) | |

TABLE 11
Compression Testing of Postcured Beads at 150° C.

| | Final | | | | | | | |
|---|---|---|---|---|---|---|---|---|
| | Cure | Stress @ | | Stress @ | Stress @ | Stress @ | Compressive | |
| | Temp | 10% | | 20% | 30% | 40% | Strength | Max |
| | (° C.) | MPa (psi) | | MPa (psi) | MPa (psi) | MPa (psi) | MPa (psi) | Deformation % |
| EX3 | 150 | 11.37 | (1649) | 16.24 (2355) | 24.55 (3561) | 48.67 (7059) | 85.89 (12458) | 42.5 |
| EX4 | 150 | 0.717 | (150) | 2.15 (312) | 5.02 (727) | 12.54 (1819) | 98.168 (14238) | 42.8 |
| EX5 | 150 | 1.053 | (150) | 2.41 (349) | 5.85 (849) | 17.21 (2496) | 59.90 (8687) | 49.0 |
| EX6 | 150 | 3.16 | (458) | 7.020 (1019) | 14.40 (2088) | 31.60 (4584) | 62.15 (9015) | 51.9 |
| EX7 | 150 | 10.390 | (1507) | 17.20 (2494) | 22.93 (3326) | 35.47 (5144) | 46.22 (6703) | 46.9 |

TABLE 12
Results of measurements of density and swelling (volume change) of epoxy beads samples in
different solvents after immersion at 70° C. for 20 hours.

| | | | | % Volume | | | |
|---|---|---|---|---|---|---|---|
| | | % Volume | % Volume | Change | % Volume | % Volume | % Volume |
| | Density | Change | Change | (80:20 | Change | change | change |
| | (g/mL) | (toluene) | (xylenes) | methanol/water) | (28% HCl) | (Kerosene) | (Frac Oil) |
| EX4 | 1.17 | 8.0 | 0.0 | 9.0 | 9.0 | 0.0 | 0.0 |
| EX5 | 1.18 | 6.0 | 0.0 | 11.0 | 7.0 | 0.0 | 0.0 |
| EX6 | 1.18 | 0.0 | 0.0 | 9.0 | 9.0 | 0.0 | 0.0 |
| EX7 | 1.20 | 0.0 | 0.0 | 7.0 | 7.0 | 0.0 | 0.0 |

### Example 8

### Synthesis of Epoxy Beads Using “D.E.R. 332” and Cycloaliphatic Amine

31.27 g of “D.E.R 332” was weighed into a polymethylpentene beaker and 7.71 g of isophoronediamine was added (stoichiometric amount). This was mixed using a Petite Digital Caframo overhead stirrer Model BDC 250 at 480 rpm for 10 min at room temperature. The mixture was then placed in a silicone oil bath at 90° C. and stirred at 480 rpm (Petite Digital Caframo overhead stirrer Model BDC 250). The sample was removed from the hot bath after 10 min (precuring time). The precured mixture was transferred to the reactor (double jacketed glass reactor, 1 liter capacity) containing 500 ml water and 2.5 g HEC in solution, stirring at 200 rpm and preheated to 90° C. using a Julabo heating bath with mineral oil. The reactor temperature was set to 30° C. after 1 hour. Epoxy beads obtained were decanted, rinsed, filtered and rinsed using treated water. Sample was dried at 20° C. The sample was placed in an oven and sequentially ramp postcured to 150° C. as per Table 13. The postcured beads were then compression tested (Table 14). Beads of 0.050+/−0.005 inches in diameter were selected for compression testing.

### Example 9

### Synthesis of Epoxy Beads Using “D.E.R. 332” and a Mixture of Aliphatic and Aromatic Diamines

30.1 g of “D.E.R. 332” was weighed into a polymethylpentene beaker and 1.04 g of an aliphatic polyetheramine “JEFFAMINE D230” (60 g/eq) and 7.08 g of an aromatic amine “LONZACURE DETDA80”. The JEFFAMINE and LONZACURE mixture was prepared in order to provide 10% of aliphatic amine and 90% of aromatic amine functional groups to cure the equivalent epoxide groups in the resin. A stoichiometric ratio between amino and epoxide groups was used. This was mixed using a Petite Digital Caframo overhead stirrer Model BDC 250 at 480 rpm for 10 min at room temperature. The mixture was then placed in a silicone oil bath at 120° C. and stirred at 480 rpm (Petite Digital Caframo overhead stirrer Model BDC 250). The sample was removed from the hot bath after 20 min (precuring time). The precured mixture was transferred to the reactor (double jacketed glass reactor, 1 liter capacity) containing 500 ml water and 2.5 g HEC in solution, stirring at 200 rpm and preheated to 90° C. using a Julabo heating bath with mineral oil. The reactor temperature was set to 30° C. after 3.5 hours. Epoxy beads obtained were decanted, rinsed, filtered and rinsed using treated water. Sample was dried at 20° C. The sample was placed in an oven and sequentially ramp postcured to 150° C. as per Table 13. The postcured beads were then compression tested (Table 14). Beads of 0.050+/−0.005 inches in diameter were selected for compression testing.

TABLE 13
Post cure conditions

| | 90° C. | 110° C. | 130° C. | 150° C. |
|---|---|---|---|---|
| EX8 | 1 hr | 1 hr | 1 hr | 2 hr |
| EX9 | 1 hr | 1 hr | 1 hr | 2 hr |

TABLE 14
Compression Testing of Postcured Beads (diameter = 0.050″ +/− 0.005) at 150° C.

| | Final | | | | | | |
|---|---|---|---|---|---|---|---|
| | Cure | Stress @ | Stress @ | Stress @ | Stress @ | Compressive | |
| | Temp | 10% | 20% | 30% | 40% | Strength | Max |
| | (° C.) | MPa (psi) | MPa (psi) | MPa (psi) | MPa (psi) | MPa (psi) | Deformation % |
| EX8 | 150 | 0.702 (102) | 1.405 (204) | 3.511 (509) | 8.428 (1222) | 76.55 (11103) | 56.5 |
| EX9 | 150 | 3.511 (509) | 6.67 (968) | 13.70 (1986) | 31.60 (4584) | 54.08 (7843) | 50.5 |

### Example 10

### Synthesis of Epoxy Beads Using a Mixture of Epoxy Resins (Novolac Epoxy and Bisphenol Epoxy)

67.0 g of D.E.N. 438 and 11.8 g D.E.R 332 (85% Novolac epoxy and 15% Bisphenol epoxy resin) were weighed into a polymethylpentene beaker. The mixture was then placed in a silicone oil bath at 115° C. and stirred for 15 min at 360 rpm (Petite Digital Caframo overhead stirrer Model BDC 250). 25.4 g of “LONZACURE DETDA 80” (25% in excess) were added while stirring at 360 rpm at 115° C. The sample was removed from the hot bath after 17 min (precuring time). The precured mixture was transferred to the reactor (double jacketed glass reactor, 1 liter capacity) containing 500 ml water and 2.5 g HEC in solution, stirring at 320 rpm and preheated to 90° C. using a Julabo heating bath with mineral oil. The reactor temperature was set to 20° C. after 2 hours. Epoxy beads obtained were decanted, rinsed, filtered and rinsed using treated water. Sample was dried at 20° C. The sample was placed in an oven and sequentially ramp postcured to 210° C. as per Table 15. The postcured beads were then compression tested (Table 16). Beads of 0.050+/−0.005 inches in diameter were selected for compression testing.

TABLE 15
Post cure conditions

| | 90° C. | 110° C. | 130° C. | 150° C. | 190° C. | 210° C. |
|---|---|---|---|---|---|---|
| EX10A | 1 hr | 1 hr | 1 hr | 2 hr | — | — |
| EX10B | 1 hr | 1 hr | 1 hr | 2 hr | 2 hr | — |
| EX10C | 1 hr | 1 hr | 1 hr | 2 hr | 2 hr | 2 hr |

TABLE 16
Compression Testing of Postcured Beads (diameter = 0.050″ +/− 0.005) at 150° C.

| | Final | | | | | | |
|---|---|---|---|---|---|---|---|
| | Cure | Stress @ | Stress @ | Stress @ | Stress @ | Compressive | |
| | Temp | 10% | 20% | 30% | 40% | Strength | Max |
| | (° C.) | MPa (psi) | MPa (psi) | MPa (psi) | MPa (psi) | MPa (psi) | Deformation % |
| EX10A | 150 | 13.34 (1935) | 16.86 (2445) | 22.82 (3310) | 42.49 (6162) | 94.46 (13700) | 50 |
| EX10B | 190 | 16.51 (2394) | 25.28 (3667) | 37.22 (5399) | 68.82 (9982) | 94.11 (13649) | 44 |
| EX10C | 210 | 19.31 (2801) | 30.20 (4380) | 42.84 (6213) | 77.25 (11204) | 109.6 (15890) | 45 |

### Comparative Example

### Synthesis of Epoxy Beads Using Alkylene Polyetheramine

25.48 g of “D.E.R. 332” was weighed into a polymethylpentene beaker and 8.86 g of “Jeffamine D230” was added. This was mixed using a Petite Digital Caframo overhead stirrer Model BDC 250 at 480 rpm for 10 min. The mixture was then placed in a silicone oil bath at 80° C. and stirred at 480 rpm (Petite Digital Caframo overhead stirrer Model BDC 250). The sample was removed from the hot bath after 10 min (precuring time). The precured mixture was transferred to the reactor (double jacketed glass reactor, 1 liter capacity) containing 500 ml water and 2.5 g HEC in solution, stirring at 200 rpm and preheated to 90° C. using a Julabo heating bath with mineral oil. The reactor temperature was set to 30° C. after 2 hours. Epoxy particles obtained were decanted, rinsed, filtered and rinsed using treated water. Sample was dried at 20° C. The resulting epoxy particles were deformable (not hard) at room temperature. That is, they were compressed with hand pressure using pliers.

### Example 11

### Synthesis of Epoxy Beads (Blend of Liquid Epoxy “D.E.R. 332” and Solid Epoxy Resin “D.E.R.661”)

39.0 g of “D.E.R. 332” (65 wt. % of epoxy resins, 172.6 g/equivalent) and 21.0 g of “D.E.R.661” (35 wt. % of epoxy resins, 539 g/equivalent) were weighed into a plastic beaker. The resins were stirred at 360 rpm and 130° C. for 30 minutes via a mechanical stirrer and silicone oil bath. Next, an excess of DETDA (125%, 14.8 g) hardener was added based on g/equiv (resin and hardener) of formulation components. The resultant solution was stirred at 360 rpm and 130° C. for an additional 14 minutes. The precured solution was then added to a double-jacketed reactor, which contained 500 mL of deionized water and 5.0 g/L of hydroxyl ethyl cellulose (HEC) in solution, preheated to 94° C., and stirred via mechanical agitation (420 rpm). After 2 hours, the reactor was cooled to 25° C. The epoxy beads were decanted, rinsed, filtered, and washed using tap-water, followed by transfer to an aluminum dish, where they were dried overnight at ambient conditions. Postcuring of the beads was carried out in an oven under air at 90° C. for one hour, 110° C. for one hour, 130° C. for one hour, 150° C. for one hour, and 190° C. for two hours. Five of the particles were then evaluated using the compression test at 150° C., three of the particles were then evaluated using the compression test at 125° C., and three of the particles were then evaluated using the compression test at 100° C. The results are shown in Tables 17, 18, and 19, below.

TABLE 17
Results of compression testing at 150° C. for epoxy beads of Example 11

| | Stress | Stress | Stress | Stress | Stress @ | Compressive | |
|---|---|---|---|---|---|---|---|
| | @10% | @20% | @30% | 40% | 50% | strength | Max |
| | MPa | MPa | MPa | MPa | MPa | MPa | Deformation |
| | (psi) | (psi) | (psi) | (psi) | (psi) | (psi) | (%) |
| | 6.03 (874) | 9.97 (1446) | 16.09 (2334) | 30.54 (4430) | 71.88 (10425) | 175.34 (25431) | 59.1 |
| | 4.9 (717) | 8.6 (1249) | 14.7 (2134) | 28.1 (4077) | 65.9 (9551) | 188.2 (27297) | 60.5 |
| | 4.81 (698) | 8.91 (1293) | 15.07 (2186) | 27.97 (4057) | 64.51 (9356) | 168.94 (24503) | 59.5 |
| | 4.96 (720) | 8.87 (1287) | 15.42 (2237) | 29.58 (4290) | 72.19 (10470) | 135.12 (19598) | 56.5 |
| | 5.18 (752) | 9.27 (1345) | 15.80 (2291) | 30.42 (4412) | 74.18 (10759) | 163.05 (23648) | 57.6 |
| Average | 5.18 (752) | 9.13 (1324) | 15.42 (2236) | 29.32 (4253) | 69.72 (10112) | 166.13 (24095) | 58.6 |
| SD* | 0.49 (70.8) | 0.53 (76.3) | 0.55 (79.9) | 1.23 (178) | 4.26 (618) | 19.69 (2856) | 1.6 |

*SD = standard deviation

TABLE 18
Results of compression testing at 125° C. for epoxy beads in Example 11

| | Stress | Stress | Stress | Stress | Stress | Compressive | |
|---|---|---|---|---|---|---|---|
| | @10% | @20% | @30% | @40% | @50% | strength | Max |
| | MPa | MPa | MPa | MPa | MPa | MPa | Deformation |
| | (psi) | (psi) | (psi) | (psi) | (psi) | (psi) | (%) |
| | 16.58 (2405) | 21.91 (3178) | 27.86 (4041) | 45.16 (6550) | 88.69 (12863) | 154.13 (22354) | 56.9 |
| | 16.25 (2357) | 21.53 (3123) | 27.48 (3986) | 44.03 (6386) | 85.69 (12428) | 147.49 (21392) | 56.7 |
| | 17.09 (2478) | 22.52 (3266) | 28.03 (4065) | 43.53 (6313) | 81.89 (11877) | 146.04 (21181) | 57.6 |
| Average | 16.64 (2413) | 21.99 (3189) | 27.79 (4031) | 44.24 (6416) | 85.42 (12389) | 149.22 (21642) | 57.1 |
| S.D. | 0.42 (60.9) | 0.50 (72.1) | 0.28 (40.5) | 0.84 (121.4) | 3.41 (494.1) | 4.31 (625.3) | 0.5 |

TABLE 19
Results of compression testing at 100° C. for epoxy beads in Example 11

| | Stress | Stress | Stress | Stress | Stress | Compressive | |
|---|---|---|---|---|---|---|---|
| | @10% | 20% | @30% | 40% | @50% | strength | Max |
| | MPa | MPa | MPa | MPa | MPa | MPa | Deformation |
| | (psi) | (psi) | (psi) | (psi) | (psi) | (psi) | (%) |
| | 20.80 (3017) | 30.25 (4388) | 36.87 (5348) | 55.58 (8061) | 101.35 (14700) | 188.87 (27393) | 58.2 |
| | 21.53 (3122) | 31.06 (4505) | 37.67 (5463) | 56.06 (8131) | 100.74 (14611) | 164.78 (23900) | 56.8 |
| | 20.70 (3003) | 30.31 (4396) | 37.01 (5368) | 55.52 (8053) | 101.61 (14738) | 231.66 (33600) | 60.5 |
| Average | 21.01 (3047) | 30.54 (4430) | 37.18 (5393) | 55.72 (8082) | 101.24 (14683) | 195.11 (28298) | 58.5 |
| S.D. | 0.45 (65.0) | 0.45 (65.4) | 0.42 (61.4) | 0.30 (42.9) | 0.45 (65.2) | 33.87 (4912.9) | 1.9 |

Particles from Example 11 were evaluated for density and swelling in various solvents according to the test methods described above. The results are shown in Table 20, below.

TABLE 20
Density and Swelling Evaluation for Example 11

| | Vol. % | Vol. % | Vol. % | Vol. % | Vol. % |
|---|---|---|---|---|---|
| Density | change | change | change | change | change |
| (g/ml) | Toluene | Xylene | 80MeOH/20 H₂O | 28% HCl | Kerosene |
| 1.17 | 21 | 7 | 13 | 4 | 1 |

### Example 12

### Synthesis of Epoxy Beads (with a Blend of Liquid Epoxy Resin “D.E.R.332”, Solid Epoxy Resin “D.E.R. 661” and Non-Aromatic Epoxy “D.E.R. 736”)

30.0 g of “D.E.R.332” (50 wt. % of epoxy resins, 172.6 g/equivalent) and 27.0 g of “D.E.R. 661” (45 wt. % of epoxy resins, 539 g/equivalent) and 3.0 g of “D.E.R. 736” (5 wt. % of epoxy resins, 190 g/equivalent) were weighed into a plastic beaker. The resins were stirred at 360 rpm and 130° C. for 25 minutes via mechanical stirrer and silicone oil bath. Next, an excess of “LONZACURE DETDA 80” (125%, 13.4 g) hardener was added based on g/equiv (resin and hardener) of formulation components; the resultant solution was stirred at 360 rpm and 130° C. for an additional 14 minutes. The precured solution was then added to a double jacketed reactor, which contained 500 mL of deionized water and 5.0 g/L of hydroxyl ethyl cellulose (HEC) in solution, preheated to 94° C., and stirred via mechanical agitation (410 rpm). After 2 hours, the reactor was cooled to 25° C. The epoxy beads were decanted, rinsed, filtered, and washed using tap-water, followed by transfer to an aluminum dish, where they were dried overnight at ambient conditions. Postcuring of the beads was carried out in an oven under air with the temperatures and times indicated in Table 21, below. Two of the particles for each of the three post-cure conditions were then evaluated using the compression test at 150° C., two of the particles for each of the three post-cure conditions were evaluated using the compression test at 125° C., and two of the particles for each of the three post-cure conditions were evaluated using the compression test at 100° C. The results, including the highest post-cure temperature (T_{cure}), are shown in Tables 22, 23, and 24, below.

TABLE 21
Post-curing conditions (temperature and time) used for epoxy beads of Example 12

| | Temperature | | | | | | | |
|---|---|---|---|---|---|---|---|---|
| Sample ID | 70° C. | 90° C. | 110° C. | 130° C. | 150° C. | 160° C. | 175° C. | 190° C. |
| EX12a | 1 h | 1 h | 1 h | 1 h | 1 h | 2 h | — | — |
| EX12b | 1 h | 1 h | 1 h | 1 h | 1 h | — | 2 h | — |
| EX12c | 1 h | 1 h | 1 h | 1 h | 1 h | — | — | 2 h |

TABLE 22
Results of compression testing at 150° C. for epoxy beads of Example 12

| | | Stress | Stress | Stress | Stress | Stress | Stress | Compressive | Max |
|---|---|---|---|---|---|---|---|---|---|
| | | @10% | @20% | @30% | @40% | @50% | @60% | strength | Defor- |
| | T_{cure} | MPa | MPa | MPa | MPa | MPa | MPa | MPa | mation |
| Example | (° C.) | (psi) | (psi) | (psi) | (psi) | (psi) | (psi) | (psi) | (%) |
| EX12a | 160 | 0.65 (93.9) | 1.72 (248.9) | 3.74 (542.9) | 9.13 (1324) | 32.85 (4764) | 119.84 (17382) | 184.01 (26688) | 63.6 |
| | | 0.60 (86.6) | 1.61 (233.9) | 3.57 (518.3) | 8.94 (1297) | 35.58 (5161) | 132.92 (19279) | 177.21 (25702) | 62.4 |
| EX12b | 175 | 0.68 (98.4) | 1.77 (256.7) | 3.94 (571.8) | 10.36 (1503) | 37.82 (5485) | 132.32 (19192) | 135.67 (19677) | 60.2 |
| | | 0.73 (105.4) | 1.85 (269.0) | 4.03 (583.9) | 10.07 (1460) | 35.38 (5131) | 124.54 (18063) | 134.45 (19500) | 60.6 |
| EX12c | 190 | 0.61 (87.9) | 1.63 (236.9) | 3.60 (522.1) | 8.94 (1296) | 32.23 (4675) | 119.40 (17318) | 174.01 (25238) | 63.1 |
| | | 0.57 (82.2) | 1.55 (225.4) | 3.46 (502.2) | 8.49 (1232) | 30.03 (4355) | 109.08 (15820) | 175.90 (25512) | 63.9 |

TABLE 23
Results of compression testing at 125° C. for epoxy beads of Example 12

| | | Stress | Stress | Stress | Stress | | Stress | Compressive | Max |
|---|---|---|---|---|---|---|---|---|---|
| | T_{cure} | @10% | @20% | @30% | @40% | Stress @50% | @60% | strength | Deformation |
| Example | (° C.) | (psi) | (psi) | (psi) | (psi) | (psi) | (psi) | (psi) | (%) |
| EX12a | 160 | 8.43 | 12.47 | 18.21 | 31.43 | 62.58 | 146.92 | 160.48 | 60.9 |
| | | (1223) | (1809) | (2641) | (4558) | (9077) | (21309) | (23276) | |
| | | 8.09 | 12.16 | 17.57 | 30.40 | 62.25 | 151.21 | 196.49 | 62.7 |
| | | (1173) | (1763) | (2549) | (4409) | (9028) | (21931) | (28498) | |
| EX12b | 175 | 8.32 | 12.05 | 17.80 | 31.27 | 63.90 | — | 106.03 | 55.9 |
| | | (1207) | (1748) | (2581) | (4536) | (9268) | — | (15378) | |
| | | 8.42 | 12.44 | 17.97 | 30.88 | 61.33 | 145.47 | 176.01 | 62.0 |
| | | (1221) | (1804) | (2606) | (4479) | (8895) | (21098) | (25528) | |
| EX12c | 190 | 8.33 | 11.90 | 17.34 | 29.89 | 60.60 | 145.33 | 184.59 | 62.5 |
| | | (1208) | (1726) | (2515) | (4335) | (8790) | (21078) | (26773) | |
| | | 8.43 | 11.96 | 17.89 | 31.30 | 64.92 | 158.49 | 175.40 | 61.0 |
| | | (1222) | (1735) | (2595) | (4539) | (9416) | (22987) | (25440) | |

TABLE 24
Results of compression testing at 100° C. for epoxy beads of Example 12

| | | Stress | Stress | Stress | Stress | Stress | Stress | Compressive | |
|---|---|---|---|---|---|---|---|---|---|
| | | @10% | @20% | @30% | @40% | @50% | @60% | strength | Max |
| | T_{cured} | MPa | MPa | MPa | MPa | MPa | MPa | MPa | Deformation |
| Example | (° C.) | (psi) | (psi) | (psi) | (psi) | (psi) | (psi) | (psi) | (%) |
| EX12a | 160 | 15.58 | 24.26 | 29.76 | 44.62 | 80.41 | 114.60 | 138.93 | 62.1 |
| | | (2259) | (3519) | (4317) | (6472) | (11662) | (16621) | (20150) | |
| EX12b | 175 | 17.51 | 24.76 | 30.05 | 44.22 | 80.23 | 124.64 | 128.54 | 60.7 |
| | | (2540) | (3591) | (4358) | (6414) | (11636) | (18077) | (18643) | |
| | | 18.89 | 25.41 | 31.18 | 46.45 | 83.14 | 179.93 | 251.33 | 63.8 |
| | | (2740) | (3686) | (4523) | (6737) | (12058) | (26097) | (36453) | |
| EX12c | 190 | 17.59 | 24.22 | 29.65 | 44.91 | 81.37 | 123.86 | 125.82 | 60.5 |
| | | (2551) | (3513) | (4300) | (6513) | (11802) | (17964) | (18249) | |
| | | 17.82 | 24.53 | 29.89 | 44.82 | 81.20 | 178.08 | 231.17 | 62.9 |
| | | (2584) | (3558) | (4335) | (6501) | (11777) | (25828) | (33529) | |

Particles from Example 12 were evaluated for density and swelling in various solvents according to the test method described above. The results are shown in Table 25, below.

TABLE 25
Swelling Evaluation for Example 12

| | Vol. % | Vol. % | Vol. % | Vol. % | Vol. % |
|---|---|---|---|---|---|
| | change | change | change | change | change |
| Example | Toluene | Xylene | 80MeOH/20 H₂O | 28% HCl | Kerosene |
| EX12a | 38 | 4 | 13 | 6 | 2 |
| EX12b | 37 | 10 | 14 | 3 | 0 |
| EX12c | 37 | 9 | 12 | 4 | 0 |

For a typical Example, epoxy beads obtained after synthesis were sieved through a set of U.S. Standard mesh sieves. The weight of every fraction was measured. The results are reported in Table 26, below.

TABLE 26
Particle size for a typical sample

| | 12-16 mesh | 16-20 mesh | 20-30 mesh | |
|---|---|---|---|---|
| <12 mesh | <1.68 mm | <1.19 mm | <0.841 mm | >30 mesh |
| >1.68 mm | >1.19 mm | >0.841 mm | >0.595 mm | <0.595 mm |
| (%) | (%) | (%) | (%) | (%) |
| 62.6 | 21.9 | 8.9 | 5.1 | 1.5 |

This disclosure may take on various modifications and alterations without departing from its spirit and scope. Accordingly, this disclosure is not limited to the above-described embodiments but is to be controlled by the limitations set forth in the following claims and any equivalents thereof. This disclosure may be suitably practiced in the absence of any element not specifically disclosed herein.

1. A plurality of solid polymer particles comprising a multifunctional aromatic epoxy crosslinked with a hardener comprising at least two amino groups and at least one of an aromatic ring or a cycloaliphatic ring, wherein in the plurality of solid polymer particles at least 90% by weight of the particles have a size in a range from 150 micrometers to 3000 micrometers.

2. The plurality of solid polymer particles of claim 1, wherein a particle from the plurality of solid polymer particles has a compressive strength of at least 45 megapascals at a temperature of 150° C.

3. A plurality of solid polymer particles comprising a multifunctional aromatic epoxy crosslinked with a hardener comprising at least two amino groups and at least one of an aromatic ring or a cycloaliphatic ring wherein a particle in the plurality of solid polymer particles has a compressive strength measured at 150° C. of at least 90 megapascals.

4. The plurality of solid polymer particles of claim 1, wherein the crosslinked aromatic epoxy comprises a novolac epoxy.

5. The plurality of solid polymer particles of claim 1, wherein the crosslinked aromatic epoxy comprises a crosslinked bisphenol diglycidyl ether.

6. The plurality of solid polymer particles of claim 1, wherein at least some of the solid polymer particles have a crosslinked network in which a molecular weight between crosslinks varies.

7. The plurality of solid polymer particles of claim 1, wherein at least some of the solid polymer particles have a crosslinked network comprising a non-aromatic epoxy.

8. The plurality of solid polymer particles of claim 1, wherein the hardener comprises an aromatic ring.

9. The plurality of solid polymer particles of claim 8, wherein the hardener comprises at least one of a phenylenediamine a diethyl toluene diamine, a diamino toluene, 1,2-diamino-3,5-dimethylbenzene, 4,5-dimethyl-1,2-phenylenediamine, 2,4,6-trimethyl-m-phenylenediamine, 2,3,5,6-tetramethyl-p-phenylenediamine, a aminobenzylamine, ethylenedianiline, 2,2′-biphenyldiamine, diaminodiphenylmethane, diaminodiphenylsulfone, a halogenated substituted phenylene diamine, a xylylenediamine, or 4-(2-aminoethyl)aniline.

10. The plurality of solid polymer particles of claim 1, wherein the crosslinked aromatic epoxy is essentially free of inorganic filler.

11. A plurality of mixed particles comprising the plurality of solid polymer particles of claim 1 and other particles comprising at least one of sand, resin-coated sand, graded nut shells, resin-coated nut shells, sintered bauxite, particulate ceramic materials, glass beads, and particulate thermoplastic materials.

12. A fluid comprising the plurality of solid polymer particles of claim 1 dispersed therein, wherein the fluid comprises at least one of water, a brine, an alcohol, carbon dioxide, nitrogen gas, or a hydrocarbon.

13. A method of fracturing a subterranean geological formation penetrated by a wellbore, the method comprising:
injecting into the wellbore penetrating the subterranean geological formation a fracturing fluid at a rate and pressure sufficient to form a fracture therein; and
introducing into the fracture a plurality of solid polymer particles comprising a multifunctional aromatic epoxy crosslinked with a hardener comprising at least two amino groups and at least one of an aromatic ring or a cycloaliphatic ring.

14. A method of making the plurality of solid polymer particles of claim 1, the method comprising:
providing a mixture comprising an aromatic epoxy resin having at least two epoxy functional groups and a hardener comprising at least two amino groups and at least one of an aromatic ring or a cycloaliphatic ring;
suspending the mixture in a solution comprising water to form a suspension; and
initiating crosslinking of the aromatic epoxy resin to make the plurality of solid polymer particles.

15. The method of claim 14, further comprising at least one of:
pre-reacting the aromatic epoxy resin and the hardener before suspending the mixture in the solution comprising water; or
separating the plurality of solid polymer particles from the solution comprising water; and
subjecting the plurality of solid polymer particles to post-polymerization heating at a temperature of at least 100° C.

16. The plurality of solid polymer particles of claim 3, wherein the crosslinked aromatic epoxy comprises a novolac epoxy.

17. The plurality of solid polymer particles of claim 3, wherein the crosslinked aromatic epoxy comprises a crosslinked bisphenol diglycidyl ether.

18. The plurality of solid polymer particles of claim 3, wherein at least some of the solid polymer particles have a crosslinked network in which a molecular weight between crosslinks varies.

19. The plurality of solid polymer particles of claim 3, wherein at least some of the solid polymer particles have a crosslinked network comprising a non-aromatic epoxy.

20. The plurality of solid polymer particles of claim 3, wherein the hardener comprises an aromatic ring.
